(19) United States
(12) Patent Application Publication
(10) Pub. No.: US 2008/0227881 A1
(43) Pub. Date: Sep. 18, 2008

(54) CELLULOSE ACETATE PROPIONATE FILM, PROCESS FOR PRODUCING CELLULOSE ACETATE PROPIONATE FILM, OPTICAL COMPENSATION SHEET, POLARIZING PLATE AND LIQUID CRYSTAL DISPLAY DEVICE

(75) Inventors: Akiko Watano, Minami-Ashigara-shi (JP); Hiroyuki Kawanishi, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/048,272

(22) Filed: Mar. 14, 2008

(30) Foreign Application Priority Data
Mar. 16, 2007 (JP) 2007-068573

(51) Int. Cl. C08G 63/60; C08J 5/18

(52) U.S. Cl. 521/182; 264/331.21

(57) ABSTRACT

A cellulose acetate propionate film has a density νe of entanglement points of a polymer chain of cellulose acetate propionate represented by the following expression (A) of from 0.3 to 2.0 moles/dm³:

νe=E_{R}′/3RT_{R} (A)

wherein R represents a gas constant; E_{R}′ represents a storage elastic modulus in a rubbery state plateau upon measurement of a dynamic viscoelasticity; and T_{R} represents a temperature in the rubbery state plateau.

### FIELD OF THE INVENTION

The present invention relates to a cellulose acetate propionate film with excellent mechanical strength and dimensional stability and a process for producing the subject cellulose acetate propionate film. In particular, the invention relates to a cellulose acetate propionate film in which a part of an acetyl group is substituted with a propionyl group, a process for producing the subject cellulose acetate propionate film and an optical compensation sheet, a polarizing plate and a liquid crystal display device each using the same.

### BACKGROUND OF THE INVENTION

Cellulose acylate films are widely used as a polarizing plate protective film for liquid crystal display device because they have adequate water vapor permeability and are easily workable. Above all, a cellulose triacetate film has hitherto been widely used and when stretched, is able to reveal retardation and to have also an optical compensation function. Furthermore, these days, a cellulose acetate propionate film obtained by substituting a part of the acetyl group with a propionyl group is also used for the same purpose. But, in the cellulose acetate propionate film, when a degree of substitution of the propionyl group is increased, its mechanical strength is inferior, and in particular, in a film obtained by aligning a polymer upon stretching to enhance in-plane anisotropy, an elastic modulus in a direction vertical to the stretching direction drops. Therefore, this film involves a problem that its dimensional stability is poor. Thus, improvements have been eagerly demanded.

As a method for enhancing the mechanical strength of the film, there is exemplified a method in which a crosslinking structure is formed by a chemical bond to enhance an elastic modulus. In JP-A-2004-292558, the fabrication is carried out in the presence of a thermally crosslinking organic compound, thereby enhancing an elastic modulus of a cellulose ester film to increase its mechanical strength.

But, there was encountered a problem that the crosslinked cellulose acylate film is poor in recovery properties.

### SUMMARY OF THE INVENTION

An object of the invention is to provide a cellulose acetate propionate film which does not have a crosslinking structure and which has high elastic modulus. Furthermore, another object of the invention is to provide an optical compensation sheet and a polarizing plate each using the subject film and a liquid crystal display device which is at least provided with either one of them.

The present inventors made extensive and intensive investigations. As a result, in a cellulose acetate propionate film, it has been found that by increasing a density of entanglement points of a polymer chain, even when a chemical crosslinking structure is not formed, the cellulose acylate film has satisfactory elastic modulus and dimensional stability and has excellent mechanical strength, leading to accomplishment of the invention.

Specifically, the invention is as follows.

[1] A cellulose acetate propionate film having a density of entanglement points (νe) of a polymer chain of cellulose acetate propionate represented by the following expression (A) of from 0.3 to 2.0 moles/dm³.

νe=E_{R}′/3RT_{R} (A)

In the foregoing expression (A), R represents a gas constant; E_{R}′ represents a storage elastic modulus in the rubbery state plateau upon measurement of a dynamic viscoelasticity; and T_{R} represents a temperature in the rubbery state plateau.

[2] The cellulose acetate propionate film as set forth in [1], wherein an elastic modulus in either one of a longitudinal direction of the film and a direction substantially orthogonal thereto is from 4.0 to 6.0 GPa, and an elastic modulus in the other direction is from 5.0 to 6.0 GPa.

[3] The cellulose acetate propionate film as set forth in [1] or [2], which does not contain a compound having a crosslinking structure.

[4] The cellulose acetate propionate film as set forth in any one of [1] to [3], wherein Re is satisfied with the range of the following expression (B), and Rth is satisfied with the range of the following expression (C).

30 nm≦Re≦100 nm (B)

70 nm≦Rth≦300 nm (C)

In the foregoing expressions (B) and (C), Re represents an in-plane retardation value of the film against light having a wavelength of 590 nm at 25° C. and 60% RH; and Rth represents a retardation value of the film in a thickness direction against light having a wavelength of 590 nm at 25° C. and 60% RH.

[5] A process for producing a cellulose acetate propionate film, which comprises casting a dope containing cellulose acetate propionate and a solvent on a band and then performing drying by blowing dry air at a temperature of from 25° C. to 40° C. at a rate of from 1 to 3 m/s until the content of the residual solvent has reached not more than 70%.

[6] The process for producing a cellulose acetate propionate film as set forth in [5], wherein a solids concentration of the dope at the time of casting is from 23 to 27%.

[7] The process for producing a cellulose acetate propionate film as set forth in [5] or [6], wherein a casting width of the film is from 2,000 to 3,000 mm.

[8] The process for producing a cellulose acetate propionate film as set forth in any one of [5] to [7], which includes the steps of casting the dope on the band in an atmosphere having an organic solvent gas concentration in the range of from 5 to 30% to form a cast film and drying it.

[9] The cellulose acetate propionate film as set forth in any one of [1] to [4], which is produced by the process according to any one of claims 5 to 8.

[10] An optical compensation sheet including the cellulose acetate propionate film as set forth in any one of [1] to [4] or [9].

[11] A polarizing plate comprising a polarizing film and two transparent protective films disposed on both sides thereof, wherein at least one of the transparent protective films is the cellulose acetate propionate film as set forth in any one of [1] to [4] or [9] or the optical compensation sheet as set forth in [10].

[12] A liquid crystal display device comprising a liquid crystal cell and two polarizing plates disposed on both sides thereof, wherein at least one of the polarizing plates is the polarizing plate as set forth in [11].

The cellulose acetate propionate film of the invention has high elastic modulus and excellent mechanical strength and dimensional stability, and the optical compensation sheet and the polarizing plate each using the subject film and the liquid crystal display device which is at least provided with either one of them have extremely high practicality.

### DETAILED DESCRIPTION OF THE INVENTION

The cellulose acylate film (the cellulose acetate propionate film will be hereinafter sometimes referred to simply as “cellulose acylate film”), the process for producing a cellulose acylate film, the optical compensation sheet, the polarizing plate and the liquid crystal display device according to the invention are hereunder described in detail.

The cellulose acylate film of the invention has a density of entanglement points (νe) of a polymer chain of a cellulose acylate represented by the following expression (A) of from 0.3 to 2.0 moles/dm³.

νe=E_{R}′/3RT_{R} (A)

In the foregoing expression (A), R represents a gas constant; E_{R}′ represents a storage elastic modulus in the rubbery state plateau upon measurement of a dynamic viscoelasticity; and T_{R} represents a temperature in the rubbery state plateau.

Here, the “density of entanglement points” according to the expression (A) is described.

When a polymer is crosslinked, a crosslinking network is formed. However, even when the polymer is not crosslinked, a network structure which is called “entanglement” is formed, and a strong mutual action is generated between the polymers. This point of mutual action is called “entanglement point”; a molecular weight between two entanglement points is called “molecular weight between entanglement points (Mₑ)”; and it is known that there is the relationship expressed by the following expression (B) (see Daigakuin: Kobunshi Kagaku (Postgraduate School: Polymer Science), pages 353 to 370, published by Kodansha Scientific Ltd.).

E_{R}′/3=ρRT_{R}/Mₑ (B)

In the foregoing expression (B), R represents a gas constant; E_{R}′ represents a storage elastic modulus in the rubbery state plateau upon measurement of a dynamic viscoelasticity; T_{R} represents a temperature in the rubbery state plateau; and p represents a mass per unit volume.

Also, entanglement points existing per unit volume are called “density of entanglement points (νe)”, and the density of entanglement points (νe) is expressed by the following expression (C).

νe=ρ/Mₑ (unit: mole/dm³) (C)

The expression (A) is derived from the expressions (B) and (C).

νe=ρ/Mₑ=E_{R}′/3RT_{R} (A)

As the entanglement of a polymer chain is generated densely, even when a stress is generated, the deformation is hardly caused, and the elastic modulus becomes high. The elastic modulus relies upon not only the density of entanglement points but a degree of crystallization and a degree of orientation. However, since the degree of crystallization and the degree of orientation are a parameter capable of largely changing optical characteristics, it is difficult to control the both at the same time. Then, according to the invention, it has become possible to prepare a film capable of realizing a high elastic modulus while revealing desired optical characteristics and having excellent mechanical strength and dimensional stability by controlling a parameter named as a degree of entanglement points, which relatively hardly affects the optical characteristics.

The expression (A) is hereunder described.

A film sample (5 mm×30 mm) is subjected to humidity conditioning at 25° C. and 60% RH for 2 hours or more and then measured by a dynamic viscoelasticity analyzer (DVA-225, manufactured by IT Keisoku Seigyo Co., Ltd.) at a rate of temperature rise of 2° C./min from 30° C. at a grip distance of 20 mm and a frequency of 1 Hz. When a storage elastic modulus E′ is plotted on the ordinate on a logarithmic scale; a temperature (K) is plotted on the abscissa on a linear scale; and between a glass transition region and a flow region, a start temperature in the rubbery state plateau where E′ exhibits a fixed value is defined as T_{Rs}, and a finish temperature is defined as T_{Rf}, T_{R}=(T_{Rs}+T_{Rf})/2 is defined as a temperature in the rubber state plateau. A density of entanglement points (νe) of the polymer can be determined by using a storage elastic modulus E_{R}′ at T_{R}. As a gas constant R, a value of 8.314 J/mole·K is employed.

In case of cellulose acetate propionate, the density of entanglement points of a polymer chain is preferably from 0.3 to 2.0 moles/dm³, more preferably from 0.5 to 1.6 moles/dm³, and most preferably from 0.65 to 1.2 moles/dm³.

When the density of entanglement points of a polymer chain of cellulose acetate propionate is less than 0.3 moles/dm³, the mechanical strength is inferior because of a low elastic modulus. On the other hand, when it is large than 2.0 moles/dm³, in stretching, breaking elongation is small, and stretching in a high stretch ratio becomes impossible.

The density of entanglement points can be increased by reducing a drying rate and performing gradual drying while developing the entanglement of a polymer chain. In order to reduce the drying rate, it is preferable to decrease a temperature of dry air and to reduce a rate of dry air.

For producing the cellulose acetate propionate film of the invention, it is preferable to employ the production process of the invention.

The production process of the cellulose acetate propionate film of the invention is a process for producing a cellulose acetate propionate film, which comprises casting a dope containing cellulose acetate propionate and a solvent on a band and then performing drying by blowing dry air at a temperature of from 25° C. to 40° C. at a rate of from 1 to 3 m/s until the content of the residual solvent has reached 70% or less.

Concretely, it is preferable to perform drying by blowing air at a temperature of from 25° C. to 40° C. at a rate of from 1 to 3 m/s during a period after casting a dope containing at least cellulose acetate propionate and a solvent on a band having a surface temperature of not higher than 10° C. and before stripping off until the content of the residual solvent has reached 70% or less.

The content of the residual solvent as referred to herein is a value obtained by calculating a proportion of the residual solvent relative to the whole of solids of the dope which is defined as 100%.

The temperature of dry air is preferably from 25° C. to 40° C., more preferably from 28° C. to 38° C., and most preferably from 30° C. to 35° C. The rate of dry air is preferably from 1 to 3 m/s, more preferably from 1.2 to 2.7 m/s, and most preferably from 1.3 to 2.5 m/s.

When the temperature of dry air is lower than 25° C., or the rate of dry air is less than 1 m/s, the productivity is poor because of a slow drying rate. Furthermore, the entanglement extremely develops, and therefore, when a stress is applied, the film does not elongate, and the breaking elongation drops. On the other hand, when the temperature of dry air exceeds 40° C., or the rate of dry air exceeds 3 m/s, drying proceeds in a state that the development of entanglement of a polymer chain of the cellulose acylate is disturbed, and therefore, the elastic modulus is low.

Also, as to a method of reducing the drying rate of the cast film, by regulating an organic solvent gas concentration in the atmosphere on the support (for example, a band or a drum) preferably in the range of from 5 to 30%, more preferably in the range of from 10 to 25%, and further preferably in the range of from 10 to 20%, it is possible to control the density of entanglement points at a desired value.

According to the conventional casting method, in order to accelerate drying of a cast film, the drying is usually performed by supplying fresh air (air having a low organic solvent concentration). Accordingly, in drying, it is general that the organic solvent gas concentration in the surroundings of the support is low as not more than 1%. There was nothing of casting a dope in an atmosphere of a high organic solvent gas concentration as in the invention.

Examples of a method of realizing such a high organic solvent gas concentration include a method in which a support or both a support and a casting machine are accommodated in a casing, and an organic solvent-containing gas to be exhausted from the casing at the time of casting and drying a dope is again supplied into the casing.

The supply and exhaust amount of the casing is preferably in the range of from 0.5 to 10 times, more preferably in the range of from 1 to 8 times, and further preferably in the range of from 1.5 to 3 times of the volume in the casing per minute.

In the process for producing a film according to the invention, since the casting rate is reduced because the drying rate is slow as compared with that in usual casting, it is possible to design to enhance the productivity due to an increase of the solids concentration of the dope and an enlargement of casing width.

### (Solids Concentration of Dope)

For the purposes of reducing the drying rate and increasing the density of entanglement points, by setting up the solids concentration of the dope high as compared with that in usual casting, it is possible to design to shorten a time required for drying. The solids concentration of the dope is preferably from 21 to 29%, and more preferably from 23 to 27%. The dope has a high concentration as compared with that in usual casting, and therefore, when dissolution is insufficient, the dissolution state can be enhanced by repeating cooling and heating operations. Whether or not the dissolution is sufficient can be judged by visually observing the appearance of the solution.

### (Casting Width)

In order to compensate the reduction of the casting rate, by widening the casting width as compared with that in usual casting, it is possible to design to enlarge an area of a film to be fabricated per unit time. The casting width is preferably from 1,800 to 4,000 mm, and more preferably from 2,000 to 3,000 mm.

In the invention, by controlling the density of entanglement points of the film by the foregoing method, it is possible to change the elastic modulus. It is preferable that the elastic modulus in either one of a longitudinal direction of the film and a direction substantially orthogonal thereto is from 4.0 to 6.0 GPa, and an elastic modulus in the other direction is from 5.0 to 6.0 GPa. Furthermore, it is more preferable that the elastic modulus in either one of a longitudinal direction of the film and a direction substantially orthogonal thereto is from 4.3 to 5.8 GPa, with the elastic modulus in the other direction being from 5.3 to 5.8 GPa; and it is the most preferable that the elastic modulus in either one of a longitudinal direction of the film and a direction substantially orthogonal thereto is from 4.4 to 4.7 GPa, with the elastic modulus in the other direction being from 5.5 to 5.7 GPa.

When the elastic modulus is smaller than 4.0 GPa, the dimensional stability is of a problem. On the other hand, when it is larger than 6.0 GPa, in stretching, breaking elongation is too small, and therefore, stretching cannot be achieved in a high stretch ratio.

As a specific measurement method, the elastic modulus can be determined by measuring a stress at an elongation of 0.5% at a tensile rate of 10%/min in an atmosphere of 23° C. and 70% RH using a universal tension tester, STM T50BP (manufactured by Toyo Baldwin Co., Ltd.).

When the elastic modulus in either one of a longitudinal direction of the film and a direction substantially orthogonal thereto is 4.0 GPa or more, the mechanical strength is excellent. On the other hand, when it is not more than 6.0 GPa, in stretching, breaking elongation is large, and stretching is easily achieved in a high stretch ratio.

Furthermore, in the foregoing measurement method of elastic modulus, by drawing the film until breakage occurs and measuring the elongation, it is possible to determine the breaking elongation.

The breaking elongation is preferably from 10% to 50%, more preferably from 20% to 45%, and most preferably from 25% to 40%.

### [Cellulose Acylate]

### (Degree of Substitution of Cellulose Acetate Propionate)

Next, cellulose acetate propionate of the invention which is produced by using the foregoing cellulose as a raw material is hereunder described. The cellulose acetate propionate to be used in the invention is one obtained by acylating a hydroxyl group of the cellulose, and as a substituent thereof, any of acyl groups including from an acetyl group having 2 carbon atoms to an acyl group having 22 carbon atoms can be used. As to the cellulose acylate to be used in the invention, the degree of substitution on the hydroxyl group of the cellulose is not particularly limited. The degree of substitution can be obtained by measurement of a degree of bond of acetic acid and/or a fatty acid having from 3 to 22 carbon atoms capable of being substituted on the hydroxyl group of the cellulose and calculation. A measurement method can be carried out in conformity with ASTM D-817-91.

Next, cellulose acetate propionate which is preferably used as the cellulose acylate film of the invention is hereunder described (the cellulose acetate propionate will be hereinafter sometimes referred to as “cellulose acylate”).

It is preferable that the cellulose acetate propionate to be used in the invention is satisfied with the following expressions (D) and (E).

2.00≦(X+Y)>3.00 (D)

1.20≦X≦2.80 (E)

In the foregoing expressions (D) and (E), X represents a degree of substitution of an acetyl group on a hydroxyl group of the cellulose; and Y represents a degree of substitution of a propionyl group on a hydroxyl group of the cellulose. The “degree of substitution” as referred to in this specification means a total sum of proportions at which hydrogen atoms of the respective hydroxyl groups at the 2-, 3- and 6-positions of the cellulose are substituted. In the case where all of hydrogen atoms of the hydroxyl groups at the 2-, 3- and 6-positions of the cellulose are substituted with an acyl group, the degree of substitution is 3.

It is more preferable that the cellulose acetate propionate to be used in the invention is satisfied with the following expressions (D′) and (E′); and it is further preferable that the cellulose acetate propionate to be used in the invention is satisfied with the following expressions (D″) and (E″).

2.20≦(X+Y)≦2.86 (D′)

1.30≦X≦2.70 (E′)

2.40≦(X+Y)≦2.80 (D″)

1.40≦X≦2.60 (E″)

The cellulose acylate film of the invention is able to make both developability of retardation and humidity dependency compatible with each other by adequately balancing hydrophobicity of the acyl group and hydrophilicity of the hydroxyl group with each other.

### (Raw Material)

As the cellulose raw material to be used in synthesizing a cellulose acylate, broad-leafed pulps, coniferous pulps and cotton linter-derived materials are preferably used.

### (Activation)

It is preferable that the cellulose raw material is subjected to a treatment (activation) for bringing it into contact with an activator prior to acylation. The activator is preferably acetic acid, propionic acid or butyric acid, and especially preferably acetic acid. The addition amount of the activator is preferably from 5% by mass to 10,000% by mass, more preferably from 10% by mass to 2,000% by mass, and further preferably from 30% bymass to 1,000% bymassrelative to the cellulose. The addition method can be selected among methods including spraying, dropping and dipping. The activation time is preferably from 20 minutes to 72 hours, and especially preferably from 20 minutes to 12 hours. The activation temperature is preferably from 0° C. to 90° C., and especially preferably from 20° C. to 60° C. Furthermore, an acylation catalyst such as sulfuric acid can be added in an amount of from 0.1% by mass to 10% by mass to the activator.

### (Acylation)

It is preferable to acylate the hydroxyl group of the cellulose by allowing the cellulose to react with an acid anhydride of a carboxylic acid in the presence of, as a catalyst, a Brønsted acid or a Lewis acid (see Rikagaku Jiten (Physicochemical Dictionary), 5th Ed. (2000)).

Examples of a method for obtaining a cellulose-mixed acylate which can be employed include a method of performing the reaction by mixing or successively adding two kinds of carboxylic acid anhydrides as an acylating agent; a method of using a mixed acid anhydride of two kinds of carboxylic acids (for example, an acetic acid/propionic acid mixed acid anhydride); a method of using, as raw materials, a carboxylic acid and an acid anhydride of another carboxylic acid (for example, acetic acid and propionic anhydride) to form a mixed acid anhydride (for example, an acetic acid/propionic acid mixed acid anhydride) in a reaction system and allowing the mixed acid anhydride to react with the cellulose; and a method of once synthesizing a cellulose acylate having a degree of substitution of less than 3 and further acylating the residual hydroxyl group by using an acid anhydride or an acid halide.

The synthesis of a cellulose acylate having a high degree of substitution at the 6-position is described in JP-A-11-5851, JP-A-2002-212338 and JP-A-2002-338601.

### (1) Acid Anhydride:

As the acid anhydride of a carboxylic acid, ones having from 2 to 22 carbon atoms in terms of a carboxylic acid can be preferably used. Above all, acetic anhydride, propionic anhydride and butyric anhydride are especially preferable. The acid anhydride is preferably added in an amount of from 1.1 to 50 equivalents, more preferably from 1.2 to 30 equivalents, and especially preferably from 1.5 to 10 equivalents to the hydroxyl group of the cellulose.

### (2) Catalyst:

The acylation catalyst to be used is preferably a Brønsted acid or a Lewis acid, more preferably sulfuric acid or perchloric acid, and especially preferably sulfuric acid. The addition amount of the acylation catalyst is preferably from 0.1 to 30% by mass, more preferably from 1 to 15% by mass, and especially preferably from 3 to 12% by mass relative to the raw material cellulose.

### (3) Solvent:

An acylation solvent is preferably a carboxylic acid, more preferably a carboxylic acid having from 2 to 7 carbon atoms, and especially preferably acetic acid, propionic acid or butyric acid. These solvents may be used in admixture.

### (4) Acylation Condition:

The acylating agent may be added at once or may be dividedly added to the cellulose. Also, the cellulose may be added at once or may be dividedly added to the acylating agent. For the purpose of controlling the temperature rise to be caused due to reaction heat of the acylation and adjusting the molecular weight, it is preferable that the acylating agent is cooled in advance. The temperature of the acylating agent is preferably from ″50° C. to 50° C., more preferably from −30° C. to 40° C., and especially preferably from −20° C. to 35° C. The lowest temperature of the reaction is preferably −50° C. or higher, more preferably −30° C. or higher, and especially preferably −20° C. or higher. The highest temperature of the reaction is preferably not higher than 50° C., more preferably not higher than 40° C., and especially preferably not higher than 35° C. The reaction time of the acylation is preferably from 0.5 hours to 24 hours, more preferably from 1 hour to 12 hours, and especially preferably from 1.5 hours to 8 hours.

### (5) Reaction Terminator:

It is preferable to add a reaction terminator after the acylation reaction. Any reaction terminator is useful so far as it is able to decompose the acid anhydride, and examples thereof include water and alcohols (those having from 1 to 3 carbon atoms). Of these, mixtures of water and a carboxylic acid (for example, acetic acid, propionic acid and butyric acid) are more preferable. With respect to the composition of water and the carboxylic acid, the proportion of water is preferably from 5% by mass to 80% by mass, more preferably from 10% by mass to 60% by mass, and especially from 15% by mass to 50% by mass.

### (6) Neutralizing Agent:

The acid catalyst may be partially or completely neutralized by the addition of a neutralizing agent at the time of or after the termination of the acylation reaction. Preferred examples of the neutralizing agent which can be used include ammoniums; organic quaternary ammoniums; and carbonates, hydrogen carbonates, organic acid salts, hydroxides or oxides of an alkali metal, a metal belonging to the group 2, a metal belonging to the groups 3 to 12 or an element belonging to the groups 13 to 15. Of these, carbonates, hydrogen carbonates, acetates or hydroxides of sodium, potassium, magnesium or calcium are especially preferable. The neutralizing agent may be added in a powder form or may be added upon being dissolved in water or an organic solvent or a mixed solvent thereof.

### (Partial Hydrolysis)

The thus obtained cellulose acylate has a total degree of substitution substantially close to 3. For the purpose of obtaining a desired degree of substitution, it is preferable that an ester linkage is partially hydrolyzed by keeping at 20 to 90° C. for several minutes to several days in the presence of a small amount of a catalyst (in general, the acylation catalyst such as residual sulfuric acid) and water, thereby reducing the degree of substitution of acyl of the cellulose acylate to a desired extent. Thereafter, it is preferable that the residual acid catalyst is completely neutralized with the foregoing neutralizing agent, thereby terminating the partial hydrolysis.

### (Filtration)

For the purpose of removing or reducing unreacted substances, sparingly soluble salts, other foreign substances and the like in the cellulose acylate, it is preferable that the reaction solution containing the cellulose acylate is filtered in any stage of from the acylation step to the reprecipitation step. A holding particle size of a filter to be used for the filtration is preferably 0.1 μm or more and not more than 50 μm, more preferably 0.5 μm or more and not more than 40 μm, and especially preferably 1 μm or more and not more than 30 μm. When the holding particle size of the filter is smaller than 0.1 μm, an increase of the filtration pressure is remarkable so that industrial production is substantially difficult. On the other hand, when the holding particle size of the filter is larger than 40 μm, there may be a possibility that the removal of foreign substances cannot be sufficiently achieved. Also, the filtration may be repeated two or more times.

### (Reprecipitation)

The cellulose acylate solution is mixed with water or a carboxylic acid (for example, acetic acid and propionic acid) and reprecipitated. The reprecipitation may be performed in any of a continuous manner or a batchwise manner.

### (Rinsing)

After the reprecipitation, it is preferable to perform a rinsing treatment. The rinsing is achieved by using water or warm water, and the termination of rinsing can be confirmed by pH, ion concentration, electric conductivity, elemental analysis or the like.

### (Stabilization)

It is preferable that the cellulose acylate after rinsing is treated with an aqueous solution of a weak alkali (for examples, carbonates, hydrogen carbonates, hydroxides or oxides of Na, K, Ca, Mg, etc.) for the purpose of enhancing the stability.

### (Drying)

It is preferable that the cellulose acylate is dried at 50 to 160° C. to an extent that its moisture content is not more than 2% by mass.

As the synthesis method of the cellulose acylate of the invention, a method described on pages 7 to 12 of Journal of Technical Disclosure, No. 2001-1745, issued Mar. 15, 2001 by Japan Institute of Invention and Innovation can also be applied.

A mass average degree of polymerization of the cellulose acylate which is favorably used in the invention is from 150 to 700, preferably from 200 to 600, and more preferably from 200 to 500. The average degree of polymerization can be measured by the molecular weight distribution measurement of gel permeation chromatography (GPC) or the like, as described in an intrinsic viscosity method by Uda, et al. (Kazuo Uda and Hideo Saito, Jour of Soc. of Textile and Cellulose Industry Japan, Vol. 18, No. 1, pages 105 to 120 (1962)). Furthermore, the measurement method of average degree of polymerization is described in detail in JP-A-9-95538.

The cellulose acylate to be used in the invention preferably has a mass average molecular weight (Mw)/number average molecular weight (Mn) ratio of from 1.5 to 5.5, more preferably from 1.5 to 5.0, and especially preferably from 2.0 to 4.5.

### [Production of Cellulose Acylate Film]

The foregoing cellulose acylate film can be produced by any usual method for producing a cellulose acylate film. In particular, it is preferable to produce the cellulose acylate film by a solvent casting method. According to the solvent casting method, the film can be produced by using a solution (dope) having a cellulose acylate dissolved in an organic solvent.

It is preferable that the organic solvent includes a solvent selected among an ether having from 3 to 12 carbon atoms, a ketone having from 3 to 12 carbon atoms, an ester having from 3 to 12 carbon atoms and a halogenated hydrocarbon having from 1 to 6 carbon atoms. Each of the ether, ketone and ester may have a cyclic structure. A compound having any two or more functional groups of an ether, a ketone and an ester (namely, —O—, —CO— and —COO—) can also be used as the organic solvent. The organic solvent may also have other functional group such as an alcoholic hydroxyl group. In case of an organic solvent having two or more kinds of functional groups, it would be better that its carbon atom number falls within the specified range of a compound having any one of the foregoing functional groups.

Examples of the ether having from 3 to 12 carbon atoms include diisopropyl ether, dimethoxymethane, dimethoxyethane, 1,4-dioxane, 1,3-dioxolan, tetrahydrofuran, anisole and phenetole.

Examples of the ketone having from 3 to 12 carbon atoms include acetone, methyl ethyl ketone, diethyl ketone, diisobutyl ketone, cyclohexanone and methylcyclohexanone.

Examples of the ester having from 3 to 12 carbon atoms include ethyl formate, propyl formate, pentyl formate, methyl acetate, ethyl acetate and pentyl acetate.

Examples of the organic solvent having two or more kinds of functional groups include 2-ethoxyethyl acetate, 2-methoxyethanol and 2-butoxyethanol.

The carbon atom number of the halogenated hydrocarbon is preferably 1 or 2, and most preferably 1. The halogen of the halogenated hydrocarbon is preferably chlorine. A proportion at which the hydrogen atom of the halogenated hydrocarbon is substituted with a halogen is preferably from 25 to 75% by mole, more preferably from 30 to 70% by mole, further preferably 35 to 65% by mole, and mostly preferably from 40 to 60% by mole. Methylene chloride is a representative halogenated hydrocarbon.

A mixture of two or more kinds of organic solvents may be used.

The cellulose acylate solution can be prepared by a general method. The “general method” as referred to herein means that the treatment is performed at a temperature of 0° C. or higher (normal temperature or high temperature). The preparation of the solution can be carried out by using a preparation method of a dope and an apparatus in a usual solvent casting method. In case of the general method, it is preferable to use a halogenated hydrocarbon (especially methylene chloride) as the organic solvent.

The amount of the cellulose acylate is adjusted such that the cellulose acylate is contained in an amount of from 10 to 40% by mass in the solution to be obtained. The amount of the cellulose acylate is more preferably from 10 to 30% by mass. An arbitrary additive as described later may be added in the organic solvent (prime solvent).

The solution can be prepared by stirring the cellulose acylate and the organic solvent at normal temperature (from 0 to 40° C.). A high-concentration solution may be stirred under a pressure and heating condition. Concretely, the cellulose acylate and the organic solvent are charged in a pressure vessel and sealed, and the mixture is stirred under pressure while heating at a temperature of a boiling point of the solvent at normal temperature or higher and within the range in which the solvent does not boil. The heating temperature is usually 40° C. or higher, preferably from 60 to 200° C., and more preferably from 80 to 110° C.

The respective components may be roughly mixed in advance and then charged in the vessel. Also, the components may be successively thrown in the vessel. The vessel is required to be configured such that stirring can be achieved. The vessel can be pressurized by injecting an inert gas such as a nitrogen gas. Also, the increase of vapor pressure of the solvent due to heating may be utilized. Alternatively, after sealing the vessel, the respective components may be added under pressure.

In case of heating, it is preferable that the vessel is heated from the outside. For example, a jacket-type heating apparatus can be used. Also, the whole of the vessel can be heated by providing a plate heat in the outside of the vessel, laying a pipe and circulating a liquid thereinto.

It is preferable to provide a stirring blade in the inside of the vessel and performing stirring by using this. The stirring blade is preferably one having a length so as to reach the vicinity of a wall of the vessel. It is preferable that a scraping blade is provided at the end of the stirring blade for the purpose of renewing a liquid film of the wall of the vessel.

Measuring instruments such as a pressure gauge and a thermometer may be provided in the vessel. In the vessel, the respective components are dissolved in a solvent. The prepared dope is cooled and then taken out from the vessel, or taken out from the vessel and then cooled by using a heat exchanger or the like.

The solution can also be prepared by a cooling dissolution method. According to the cooling dissolution method, the cellulose acylate can be dissolved even in an organic solvent in which it is difficult to dissolve the cellulose acylate in a usual dissolution method. According to the cooling dissolution method, there is brought an effect that a uniform solution can be rapidly obtained even by using a solvent capable of dissolving the cellulose acylate therein in a usual dissolution method.

In the cooling dissolution method, first of all, a cellulose acylate is gradually added in an organic solvent at room temperature while stirring. It is preferable that the amount of the cellulose acylate is adjusted such that from 10 to 40% by mass of the cellulose acylate is contained in this mixture. The amount of the cellulose acylate is more preferably from 10 to 30% by mass. Furthermore, an arbitrary additive as described later may be added in the mixture.

Next, the mixture is cooled to a temperature of from −100 to −10° C. (preferably from −80 to −10° C., more preferably from −50 to −20° C., and most preferably from −50 to −30° C.). The cooling can be carried out in, for example, a dry ice/methanol bath (−75° C.) or a cooled diethylene glycol solution (from −30 to −20° C.). By performing cooling in such a manner, the mixture of a cellulose acylate and an organic solvent is solidified.

A cooling rate is preferably 4° C./min or more, more preferably 8° C./min or more, and most preferably 12° C./min or more. It is preferable that the cooling rate is as fast as possible. However, 10,000° C./sec is a theoretical upper limit; 1,000° C./sec is a technical upper limit; and 100° C./sec is a practical upper limit. The cooling rate is a value obtained by dividing a difference between a temperature at which cooling is started and a final cooling temperature by a time of from the start of cooling to the arrival at the final cooling temperature.

When the resulting mixture is further heated to a temperature of from 0 to 200° C. (preferably from 0 to 150° C., more preferably from 0 to 120° C., and most preferably from 0 to 50° C.), the cellulose acylate is dissolved in the organic solvent. The temperature rise may be achieved by merely allowing the mixture to stand at room temperature or by heating in a warm bath. A heating rate is preferably 4° C./min or more, more preferably 8° C./min or more, and most preferably 12° C./min or more. It is preferable that the heating rate is as fast as possible. However, 10,000° C./sec is a theoretical upper limit; 1,000° C./sec is a technical upper limit; and 100° C./sec is a practical upper limit. The heating rate is a value obtained by dividing a difference between a temperature at which heating is started and a final heating temperature by a time of from the start of heating to the arrival at the final heating temperature.

A uniform solution is thus obtained in the foregoing manner. In the case where the dissolution is insufficient, the cooling and heating operation may be repeated. Whether or not the dissolution is sufficient can be judged merely by visual observation of the appearance of the solution.

In the cooling dissolution method, in order to avoid the incorporation of moisture due to dew condensation at the time of cooling, it is desired to use a sealed vessel. In the cooling and heating operation, when pressurization is carried out at the time of cooling, or evacuation is carried out at the time of heating, the dissolution time can be shortened. In order to carry out the pressurization and evacuation, it is desired to use a pressure vessel.

In a 20% by mass solution obtained by dissolving a cellulose acylate (degree of acetylation: 60.9%, viscosity average polymerization degree: 299) in methyl acetate by a cooling dissolution method, according to differential scanning calorimetry (DSC), a pseudo-phase transition point between a sol state and a gel state exists in the vicinity of 33° C., and the solution becomes in a uniform gel state at a temperature of not higher than this temperature. Accordingly, this solution is required to be stored at a temperature of the pseudo-phase transition temperature or higher, and preferably a temperature of about 10° C. higher than the gel phase transition temperature. However, this pseudo-phase transition temperature varies with the degree of acetylation and viscosity average polymerization degree of the cellulose acylate, the solution concentration and the organic solvent to be used.

A cellulose acylate film can be produced from the prepared cellulose acylate solution (dope) by a solvent casting method.

The dope is cast on a drum or a band, and the solvent is vaporized to form a film. It is preferable that the dope before casting is adjusted so as to have a concentration in the range of from 18 to 35% in terms of solids content. It is preferable that the surface of the drum or band is mirror-finished. The casting and drying method in the solvent casting method is described in U.S. Pat. Nos. 2,336,310, 2,367,603, 2,492,078, 2,492,977, 2,492,978, 2,607,704, 2,739,069 and 2,739,070, U.K. Patents Nos. 640,731 and 736,892, JP-B-45-4554, JP-B-49-5614, JP-A-60-176834, JP-A-60-203430, and JP-A-62-115035.

It is preferable that the dope is cast on a drum or a band having a surface temperature of not higher than 10° C. It is preferable that after casting, air is blown for 2 seconds or more to achieve drying. Also, the resulting film is stripped off from the drum or band and further dried by high-temperature air while successively changing the temperature from 100° C. to 160° C., whereby the residual solvent can be evaporated. The foregoing method is described in JP-B-5-17844. According to this method, it is possible to shorten a time of from casting to stripping-off. In order to achieve this method, it is necessary that the dope is gelled at the surface temperature of the drum or band at the casting.

### [Additive]

In order to improve the mechanical physical properties, a plasticizer can be added in the cellulose acylate film. As the plasticizer, a phosphoric ester or a carboxylic acid ester is used. Examples of the phosphoric ester include triphenyl phosphate (TPP) and tricresyl phosphate (TCP). As the carboxylic acid, a phthalic ester and a citric ester are representative. Examples of the phthalic ester include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citric ester include triethyl O-acetylcitrate (OACTE) and tributyl O-acetylcitrate (OACTB). Examples of other carboxylic acid esters include butyl oleate, methylacetyl ricinolate, dibutyl sebacate and various trimellitic esters. Phthalic ester based plasticizers (for example, DMP, DEP, DBP, DOP, DPP and DEHP) are preferably used. DEP and DPP are especially preferable.

The addition amount of the plasticizer is preferably from 0.1 to 25% by mass, more preferably from 1 to 20% by mass, and most preferably from 3 to 15% by mass relative to the amount of the cellulose acylate.

In the cellulose acylate film, a deterioration preventive agent (for example, an antioxidant, a peroxide decomposing agent, a radical inhibitor, a metal inactivating agent, an acid scavenger and an amine) may be added. The deterioration preventive agent is described in JP-A-3-199201, JP-A-5-197073, JP-A-5-194789, JP-A-5-271471 and JP-A-6-107854. From the viewpoints of revealing an effect by the addition of the deterioration preventive agent and suppressing bleed-out of the deterioration preventive agent onto the film surface, the addition amount of the deterioration preventive agent is preferably from 0.01 to 1% by mass, and more preferably from 0.01 to 0.2% by mass relative to the solution (dope) to be prepared. Examples of the deterioration preventive agent which is especially preferable include butylated hydroxytoluene (BHT) and tribenzylamine (TBA).

### (Matting Agent Fine Particle)

In the cellulose acylate film of the invention, it is preferable to add a fine particle as a matting agent. Examples of the fine particle which is used in the invention include silicon dioxide, titanium dioxide, aluminum oxide, zirconium oxide, calcium carbonate, calcium carbonate, talc, clay, calcined kaolin, calcined calcium silicate, hydrated calcium silicate, aluminum silicate, magnesium silicate and calcium phosphate. As the fine particle, one containing silicon is preferable in view of the matter that the turbidity is low, and silicon dioxide is especially preferable. As the fine particle of silicon dioxide, one having an average particle size of primary particle of not more than 20 nm and an apparent specific gravity of 70 g/L or more is preferable. One having a small average particle size of primary particle as from 5 to 16 nm is more preferable because the haze of the film can be reduced. The apparent specific gravity is preferably from 90 to 200 g/L or more, and more preferably from 100 to 200 g/L or more. What the apparent specific gravity is large is preferable because a dispersion with high concentration can be prepared, and the haze and the coagulated material are improved.

Such a fine particle usually forms a secondary particle having an average particle size of from 0.1 to 3.0 μm. The fine particle exists as a coagulated material of the primary particle in the film and forms irregularities of from 0.1 to 3.0 μm on the film surface. The average particle size of the secondary particle is preferably 0.2 μm or more and not more than 1.5 μm, more preferably 0.4 μm or more and not more than 1.2 μm, and most preferably 0.6 μm or more and not more than 1.1 μm. The primary or secondary particle size of the fine particle was defined in terms of a diameter of a circle which touches externally the particle upon observation of the particle in the film by a scanning electron microscope. Also, by changing the place and observing 200 particles, its average value was defined as an average particle size.

As the fine particle of silicon dioxide, commercially available products such as AEROSIL R972, AEROSIL R972V, AEROSIL R974, AEROSIL R812, AEROSIL 200, AEROSIL 200V, AEROSIL 300, AEROSIL R202, AEROSIL OX50 and AEROSIL TT600 (all of which are manufactured by Nippon Aerosil Co., Ltd.) can be used. The fine particle of zirconium oxide is commercially available as a trade name, for example, AEROSIL R976 and AEROSIL R811 (all of which are manufactured by Nippon Aerosil Co., Ltd.), and these products can be used.

Of these, AEROSIL 200V and AEROSIL R972V are especially preferable because they are a fine particle of silicon dioxide having an average particle size of primary particle of not more than 20 nm and an apparent specific gravity of 70 g/L or more and have a large effect for reducing a coefficient of friction while keeping the turbidity of an optical film low.

In the invention, in order to obtain a cellulose acylate film containing a particle having a small average particle size of secondary particle, some methods can be thought in preparing a dispersion of a fine particle. For example, there is a method in which a fine particle dispersion having a solvent and a fine particle stirred and mixed therein is previously prepared, this fine particle dispersion is added in a small amount of a separately prepared cellulose acylate solution and stirred for dissolution, and the mixture is then mixed with the main cellulose acylate dope solution. This method is a preferred preparation method from the standpoints that the dispersibility of the silicon dioxide fine particle is good and that the silicon dioxide fine particle is further hardly recoagulated. Besides, there is a method in which a small amount of a cellulose ester is added in a solvent and stirred for dissolution; a fine particle is then added thereto; the mixture is dispersed by a dispersing machine to form a fine particle addition solution; and this fine particle addition solution is thoroughly mixed with a dope solution in an in-line mixer. It should not be construed that the invention is limited to these methods. When the silicon dioxide fine particle is mixed and dispersed in a solvent or the like, the concentration of silicon oxide is preferably from 5 to 30% by mass, more preferably from 10 to 25% by mass, and most preferably from 15 to 20% by mass. What the dispersion concentration is high is preferable in view of the matters that the turbidity of the liquid relative to the addition amount is low and that the haze and the coagulated material are improved. The addition amount of the matting agent in the final dope solution of the cellulose acylate is preferably from 0.01 to 1.0 g, more preferably from 0.03 to 0.3 g, and most preferably from 0.08 to 0.16 g per 1 m².

As the solvent to be used, lower alcohols are exemplified. Preferred examples thereof include methyl alcohol, ethyl alcohol, propyl alcohol, isopropyl alcohol and butyl alcohol. Other solvents than the lower alcohol are not particularly limited. It is preferable to use the solvent which is used at the time of fabrication of a cellulose ester.

The formation of a film can also be carried out by using the prepared cellulose acylate solution (dope) and casting it into two or more layers. In that case, it is preferable to prepare the cellulose acylate film by a solvent casting method. The dope is cast on a drum or a band, and the solvent is vaporized to form a film. It is preferable that the dope before casting is adjusted so as to have a concentration in the range of from 10 to 40% in terms of solids content. It is preferable that the surface of the drum or band is mirror-finished.

In case of casting the cellulose acylate solution of two or more plural layers, plural cellulose acylate solutions can be cast. A film may be prepared while casting each cellulose acylate-containing solution from plural casting nozzles provided at intervals in the movement direction of the support and stacking. For example, methods described in JP-A-61-158414, JP-A-1-122419 and JP-A-11-198285 can be employed. Also, the formation of a film can also be carried out by casting the cellulose acylate solution from two casting nozzles. For example, methods described in JP-B-60-27562, JP-A-61-94724, JP-A-61-94725, JP-A-61-104813, JP-A-61-158413 and JP-A-6-134933 can be employed. Furthermore, a casting method described in JP-A-56-162617, in which a flow of a high-viscosity cellulose acylate solution is encompassed by a low-viscosity cellulose acylate solution, and the high-viscosity and low-viscosity cellulose acylate solutions are simultaneously extruded, can also be employed.

Also, a film can be prepared by using two casting nozzles, stripping off a film formed on a support by a first casting nozzle and then subjecting the side of the film coming into contact with the support surface to second casting. For example, a method described in JP-B-44-20235 can be exemplified.

With respect to the cellulose acylate solution to be cast, the same solution may be used, or different cellulose solutions may be used. For the purpose of making plural cellulose acylate layers have a function, a cellulose acylate solution corresponding to each function may be extruded from each casting nozzle. Furthermore, the cellulose acylate solution of the invention can be cast simultaneously with other functional layers (for example, an adhesive layer, a dye layer, an antistatic layer, an anti-halation layer, an ultraviolet ray absorbing layer and a polarizing layer).

In conventional single-layer solutions, in order to bring the film with a necessary thickness, it is required to extrude a high-viscosity cellulose acylate solution in a high concentration. In that case, there was often encountered a problem that the stability of the cellulose acylate solution is so poor that solids are generated, thereby causing a spitting fault or inferiority in flatness. As a method for solving this problem, by casting plural cellulose acylate solutions from casting nozzles, high-viscosity solutions can be extruded onto the support at the same time, and a film having improved flatness and excellent surface properties can be prepared. Also, by using concentrated cellulose acylate solutions, a reduction of a drying load can be achieved, and the production speed of the film can be enhanced.

It is preferable that the cellulose acylate film is stretched in a stretch ratio of from 1.05 to 1.8 times in one direction and in a stretch ratio of from 0.9 to 1.5 times in the other direction; it is more preferable that the cellulose acylate film is stretched in a stretch ratio of from 1.1 to 1.6 times in one direction and in a stretch ratio of from 1.0 to 1.4 times in the other direction; and it is especially preferable that the cellulose acylate film is stretched in a stretch ratio of from 1.1 to 1.5 times in one direction and in a stretch ratio of from 1.0 to 1.3 times in the other direction. As to the stretching, longitudinal stretching and lateral stretching may be carried out simultaneously or separately, and a web can be stretched during a time of from stripping off the web from the casting support to completion of drying. It is preferable to include a step of performing stretching longitudinally and laterally at the same time. According to this, it is possible to obtain a cellulose acylate film having not only excellent optical isotropy but satisfactory flatness. It is preferable that the width control or stretching in a lateral direction in the fabrication step is carried out by using a tenter; the tenter may be any of a pin tenter and a clip tenter; and a biaxial stretching tenter is especially preferably used.

The circumferential temperature at the time of stretching is preferably 110° C. or higher and not higher than 150° C., more preferably 115° C. or higher and not higher than 140° C., and most preferably 120° C. or higher and not higher than 135° C.

A stretching rate in the width direction of the film is preferably from 50%/min to 30%/min, more preferably from 100%/min to 400%/min, and most preferably from 100%/min to 300%/min.

As a winder which is used in producing the cellulose acylate film of the invention, a generally used winder can be used; and the cellulose acylate film can be wound up by a winding method, for example, a constant-tension method, a constant-torque method, a taper tension method and a program tension control method in which an internal stress is constant.

### [Glass Transition Temperature of Cellulose Acylate Film]

A glass transition temperature of the cellulose acylate film can be measured by a method described in JIS K7121.

A glass transition temperature of the cellulose acylate film of the invention is preferably 80° C. or higher and not higher than 200° C., and more preferably 100° C. or higher and not higher than 170° C. It is possible to lower the glass transition temperature by adding a low-molecular weight compound such as a plasticizer and a solvent.

### [Thickness of Film]

Also, a thickness (dry thickness) of the cellulose acylate film is not more than 120 μm, preferably from 20 to 100 μm, and more preferably from 30 to 90 μm.

### [Retardation of Film]

In this specification, Re(λ) and Rth(λ) represent a front retardation and a retardation in a film thickness direction at a wavelength of λ, respectively. The Re(λ) is measured by making light having a wavelength of λ nm incident in a normal direction of the film in KOBRA 21ADH (manufactured by Oji Scientific Instruments). The Rth(λ) is computed by KOBRA 21ADH on the basis of retardation values measured in three directions in total including the foregoing Re(λ), a retardation value measured by making light having a wavelength of λ nm incident from an inclined direction at +40 degrees against the normal direction of the film by forming an in-plane slow axis (judged by KOBRA 21ADH) as an axis of tilt (rotating axis) and a retardation value measured by making light having a wavelength of λ nm incident from an inclined direction at −40 degrees against the normal direction of the film by forming the in-plane slow axis as an axis of tilt (rotating axis), a hypothesized value of average refractive index and an inputted film thickness value.

Here, as the hypothesized value of average refractive index, values described in Polymer Handbook (John Wiley & Sons, Inc.) and catalogues of various optical films can be employed. When a value of average refractive index is not known, it can be measured by an ABBE's refractometer.

Values of average refractive index of major optical films are enumerated as follows: cellulose acylate (1.48), cycloolefin polymer (1.52), polycarbonate (1.59), polymethyl methacrylate (1.49) and polystyrene (1.59). By inputting such a hypothesized value of average refractive index and a thickness of the film, nₓ (refractive index in the fabrication direction), n_{y} (refractive index in the width direction) and n_{z} (refractive index in the thickness direction) are computed by KOBRA 21ADH.

The cellulose acylate film of the invention can be favorably used as a protective film for polarizing plate in a liquid crystal display device. In that case, the Re at 25° C. and 60% RH of the cellulose acylate film at 590 nm is preferably from 30 to 100 nm, more preferably from 30 to 90 nm, and most preferably from 40 to 80 nm. Also, the Rth at 25° C. and 60% RH of the cellulose acylate film at 590 nm is preferably from 70 nm to 300 nm, more preferably from 80 nm to 270 nm, and most preferably from 90 nm to 250 nm.

### [Humidity Dependency of Re and Rth of Film]

It is preferable that both the in-plane retardation Re and the retardation Rth in the film thickness direction of the cellulose acylate film of the invention are small in change to be caused due to the humidity. A difference ΔRe between an Re value at 25° C. and 10% RH and an Re value at 25° C. and 80% RH (ΔRe=Re(10% RH)−Re(80% RH)) is preferably from 0 to 30 nm, more preferably from 0 to 20 nm, and further preferably from 0 to 15 nm. Also, a difference ΔRth between an Rth value at 25° C. and 10% RH and an Rth value at 25° C. and 80% RH (ΔRth=Rth(10% RH)−Rth(80% RH)) is preferably from 0 to 50 nm, more preferably from 0 to 40 nm, and further preferably from 0 to 25 nm.

### [Moisture Content of Cellulose Acylate Film]

The moisture content of the cellulose acylate film can be evaluated by measuring the equilibrium moisture content at fixed temperature and relative humidity. The equilibrium moisture content is one obtained by allowing a sample to stand at fixed temperature and relative humidity for 24 hours, measuring the water content of the sample which has reached the equilibrium state by the Karl Fischer's method and dividing the water content (g) by the sample weight (g).

The equilibrium moisture content of the cellulose acylate film of the invention at 25° C. and 80% RH is preferably not more than 6% by weight, more preferably not more than 4% by weight, and most preferably not more than 3.5% by weight.

### [Water Vapor Permeability]

A water vapor permeability is obtained by measuring a water vapor permeability of each sample by a method described in JIS Z0208 and computing as the content (g) of water vaporized for 24 hours per an area of 1 m².

The water vapor permeability of the cellulose acylate film can be adjusted by various methods.

It is possible to lower the water vapor permeability by adding a hydrophobic compound to the cellulose acylate film, thereby lowering the moisture content of the cellulose acylate film. It is also possible to lower the water vapor permeability by stretching in the conveyance direction and/or width direction at the time of fabrication, thereby making the alignment of the molecular chain of the cellulose acylate dense.

The water vapor permeability of the cellulose acylate film of the invention as measured by a method under Condition A in conformity with JIS Z0208 is preferably 20 g/m² or more and not more than 250 g/m², more preferably 40 g/m² or more and not more than 225 g/m², and most preferably 100 g/m² and not more than 200 g/m².

### [Dimensional Stability]

With respect to the dimensional stability of the cellulose acylate film of the invention, it is preferable that a rate of dimensional change in case of allowing the cellulose acylate film to stand under a condition at 90° C. and 5% RH for 24 hours (at a high humidity) is preferably not more than 0.10%.

The rate of dimensional change of the cellulose acylate film is more preferably not more than 0.06%, and further preferably not more than 0.03%.

As a concrete measurement method, two cellulose acylate film samples (30 mm×120 mm) were prepared, humidified at 25° C. and 60% RH for 24 hours and provided with punches of 6 mmφ at intervals of 100 mm in both ends thereof by an automatic pin gauge (manufactured by Shinto Scientific Co., Ltd.); and a punch interval was defined as an original dimension (L0). One of the samples was treated at 90° C. and 5% RH for 24 hours and then measured for a dimension of the punch interval (L1). In the measurement of all of the intervals, the measurement was carried out to a degree of a minimum scale of 1/1000 mm. The rate of dimensional change was determined according to the following expression.

Rate of dimensional change at 90° C. and 5% RH (at a high temperature)={↑L0−L1|/L0}×100

The dimensional change of the cellulose acylate film is mainly caused by elongation or shrinkage of the film due to heat. When the elastic modulus of the cellulose acylate film is high, the dimensional stability is satisfactory.

### [Photoelasticity]

A coefficient of photoelasticity of the cellulose acylate film of the invention is preferably not more than 60×10⁻⁸ cm²/N, and more preferably not more than 20×10⁻⁸ cm²/N. The coefficient of photoelasticity can be determined by an ellipsometer.

### [Haze of Film]

A haze of the cellulose acylate film of the invention is preferably from 0.01 to 0.80%, more preferably from 0.01 to 0.60%, and further preferably from 0.01 to 0.30%. What the haze exceeds 0.80% is not preferable because when the cellulose acylate film is stuck to a panel, the brightness is reduced.

The haze of the cellulose acylate film sample (40 mm×80 mm) of the invention was measured at 25° C. and 60% RH by using a haze meter (HGM-2DP, manufactured by Suga Test Instruments Co., Ltd.) in conformity with JIS K-6714.

### (Surface Treatment)

When the cellulose acylate film of the invention is subjected to a surface treatment as the case may be, an enhancement of adhesiveness of the cellulose acylate film to each of the functional layers (for example, an undercoat layer and a back layer) can be achieved. For example, a glow discharge treatment, an irradiation treatment with ultraviolet rays, a corona treatment, a flame treatment and an acid or alkali treatment can be employed. The glow discharge treatment as referred to herein may be a treatment with a low-temperature plasma occurred under a low-pressure gas of from 10⁻³ to 20 Torr, and a treatment with plasma under an atmospheric pressure is also preferable. A plasma-exciting gas refers to a gas which is plasma excited under the foregoing condition, and examples thereof include argon, helium, neon, krypton, xenon, nitrogen, carbon dioxide, chlorofluorocarbons such as tetrafluoromethane and mixtures thereof. These are described in detail on pages 30 to 32 of Journal of Technical Disclosure, No. 2001-1745, issued Mar. 15, 2001 by Japan Institute of Invention and Innovation. In the treatment with plasma under an atmospheric pressure to which attention is recently paid, for example, irradiation energy of from 20 to 500 kGy under from 10 to 1,000 keV is preferably used, and irradiation energy of from 20 to 300 kGy under from 30 to 500 keV is more preferably used. Above all, an alkali saponification treatment is especially preferable and extremely effective as a surface treatment of the cellulose acylate film.

It is preferable that the alkali saponification treatment is carried out by a method of directly dipping the cellulose acylate film in a tank of a saponification solution or a method of coating a saponification solution on the cellulose acylate film.

Examples of the coating method include a dip coating method, a curtain coating method, an extrusion coating method, a bar coating method and an E-type coating method. As to the solvent of the coating solution for alkali saponification treatment, it is preferable to choose a solvent having good wettability for the purpose of coating the saponification solution on a transparent support and capable of keeping good surface properties without forming irregularities on the surface of the transparent support by the saponification solution solvent. Concretely, alcoholic solvents are preferable, and isopropyl alcohol is especially preferable. Also, an aqueous solution of a surfactant can be used as the solvent. The alkali of the alkali saponification solution is preferably an alkali which is soluble in the foregoing solvent, and more preferably KOH or NaOH. The pH of the saponification coating solution is preferably 10 or more, and more preferably 12 or more. As to the reaction condition at the time of alkali saponification, the reaction is preferably carried out at room temperature for one second or more and not more than 5 minutes, more preferably 5 seconds or more and not more than 5 minutes, and especially preferably 20 seconds or more and not more than 3 minutes. After the alkali saponification reaction, it is preferable that the saponification solution-coated surface is washed with water or rinsed with an acid and then washed with water.

### (Antireflection Layer)

It is preferable that a functional film such as an antireflection layer is provided on a transparent protective film to be disposed on a polarizing plate on an opposite side to a liquid crystal cell. In particular, in the invention, an antireflection layer in which at least a light scattering layer and a low refractive index layer are stacked in this order on a transparent protective film; or an antireflection layer in which a middle refractive index layer, a high refractive index layer and a low refractive index layer are stacked in this order on a transparent protective film is favorably used. These preferred examples are hereunder described.

A preferred example of an antireflection layer in which a light scattering layer and a low refractive index layer are provided on a transparent protective film is hereunder described.

In the light scattering layer of the invention, a mat particle is dispersed. It is preferable that a refractive index of the raw material in a portion other than the mat particle of the light scattering layer is in the range of from 1.50 to 2.00; and it is preferable that a refractive index of the low refractive index layer is in the range of from 1.35 to 1.49. In the invention, the light scattering layer has both antiglare properties and hard coat properties and may be configured of a single layer or plural layers (for example, from two layers to four layers).

It is preferable to design the antireflection layer of the invention such that with respect to the surface irregular shape, a central line mean roughness (Ra) is from 0.08 to 0.40 μm; that a ten-point mean roughness (Rz) is not more than 10 times of Ra; that an average crest/root distance (Sm) is from 1 to 100 μm; that a standard deviation of a height of the convex from the deepest part of irregularities is not more than 0.5 μm; that a standard deviation of the average crest/root distance (Sm) on the basis of the central line is not more than 20 μm; and that a face with an inclination angle of from 0 to 5 degrees accounts for 10% or more because both sufficient antiglare properties and visually uniform mat feeling are achieved.

Also, it is preferable that a ratio between a minimum value and a maximum value of a reflectance within the ranges of from −2 to 2 for the a* value and from −3 to 3 for the b* value at a wavelength in the range of from 380 nm to 780 nm with respect to a color taste of reflected light under a C light source is from 0.5 to 0.99 because the color taste of reflected light becomes neutral. Furthermore, it is preferable that the b* value of transmitted light under a C light source is from 0 to 3 because when applied to a display device, a yellow taste of the white display is reduced.

Also, it is preferable that a standard deviation of brightness distribution obtained by inserting a grating of 120 μm×40 μm between a surface light source and the antireflection film of the invention and measuring the brightness distribution on the film is not more than 20 because glare at the time of applying the film of the invention to a high-definition panel is reduced.

As to optical characteristics, it is preferable that the antireflection layer of the invention has a mirror reflectance of not more than 2.5%, a transmittance of 90% or more and a 60-degree glossiness of not more than 70% because the reflection of external light can be suppressed, and the visibility is enhanced. In particular, the mirror reflectance is more preferably not more than 1%, and most preferably not more than 0.5%. It is preferable that the haze is from 20% to 50%; that an internal haze/total haze value (ratio) is from 0.3 to 1; that a reduction from the haze value to the light scattering layer to the haze value after forming the low refractive index layer is not more than 15%; that a transmitted image clarity at a comb width of 0.5 mm is from 20% to 50%; and that a transmittance ratio of vertical transmitted light/transmitted light in a direction inclined at 2 degrees from the vertical direction is from 1.5 to 5.0 because prevention of glare and reduction of blur of letters, etc. on a high-definition LCD panel are achieved.

### (Low Refractive Index Layer)

The refractive index of the low refractive index layer of the antireflection film of the invention is in the range of from 1.20 to 1.49, and preferably from 1.30 to 1.44. Furthermore, in view of realizing a low reflectance, it is preferable the low refractive index layer is satisfied with the following numerical expression (IX).

(mλ/4)×0.7<n1d1<(mλ/4)×1.3 Numerical Expression (IX)

In the foregoing expression (IX), m represents a positive odd number; n1 represents a refractive index of the low refractive index layer; d1 represents a film thickness (nm) of the low refractive index layer; and λ represents a wavelength and is a value in the range of from 500 to 550 nm.

The raw material for forming the low refractive index layer of the invention is hereunder described.

The low refractive index layer of the invention contains a fluorine-containing polymer as a low refractive index binder. The fluorine-containing polymer is preferably a fluorine-containing polymer having a coefficient of dynamic friction of from 0.03 to 0.20, a contact angle against water of from 90 to 120 degrees and a slipping down angle of pure water of not more than 70 degrees and capable of being crosslinked by heat or ionizing radiations. In the case where the antireflection film of the invention is installed in an image display device, it is preferable that a peeling force from a commercially available pressure sensitive adhesive tape is low as far as possible because it is readily peeled away after sticking a seal or memorandum. The peeling force is preferably not more than 500 gf, more preferably not more than 300 gf, and most preferably not more than 100 gf. Also, when a surface hardness as measured by a micro hardness meter is high, a scar is hardly formed. The surface hardness is preferably 0.3 GPa or more, and more preferably 0.5 GPa or more.

Examples of the fluorine-containing polymer which is used in the low refractive index layer include fluorine-containing copolymers composed of a fluorine-containing monomer unit and a constitutional unit for imparting crosslinking reactivity as constitutional components, in addition to hydrolyzates or dehydration condensates of a perfluoroalkyl group-containing silane compound [for example, (heptadecafluoro-1,1,2,2-tetra-hydrodecyl)triethoxysilane].

Specific examples of the fluorine-containing monomer include fluoroolefins (for example, fluoroethylene, vinylidene fluoride, tetrafluoroethylene, perfluorooctylethylene, hexafluoropropylene and perfluoro-2,2-dimethyl-1,3-dioxol), partially or completely fluorinated alkyl ester derivatives of (meth)acrylic acid (for example, “VISCOAT 6FM” (manufactured by Osaka Organic Chemical Industry Ltd.) and “M-2020” (manufactured by Daikin Industries, Ltd.)) and completely or partially fluorinated vinyl ethers. Of these, perfluoroolefins are preferable; and hexafluoropropylene is especially preferable from the viewpoints of refractive index, solubility, transparency, easiness of availability and so on.

Examples of the constitutional unit for imparting crosslinking reactivity include constitutional units obtainable by polymerization of a monomer having a self-crosslinking functional group in a molecule thereof in advance (for example, glycidyl (meth)acrylate and glycidyl vinyl ether); constitutional units obtainable by polymerization of a monomer having a carboxyl group, a hydroxyl group, an amino group, a sulfo group, etc. [for example, (meth)acrylic acid, methylol (meth)acrylate, hydroxyalkyl (meth)acrylates, allyl acrylate, hydroxyethyl vinyl ether, hydroxybutyl vinyl ether, maleic acid and crotonic acid]; and constitutional units in which a crosslinking reactive group such as a (meth)acryloyl group is introduced into such a constitutional unit by a polymeric reaction (for example, the crosslinking reactive group can be introduced by a method for allowing acrylic chloride to act on a hydroxyl group).

Also, besides the foregoing fluorine-containing monomer unit and constitutional unit for imparting crosslinking reactivity, from the viewpoints of solubility in a solvent, transparency of a film and so on, a fluorine atom-free monomer can be properly copolymerized. The monomer unit which can be used jointly is not particularly limited, and examples thereof include olefins (for example, ethylene, propylene, isoprene, vinyl chloride and vinylidene chloride), acrylic esters (for example, methyl acrylate, ethyl acrylate and 2-ethylhexyl acrylate), methacrylic esters (for example, methyl methacrylate, ethyl methacrylate, butyl methacrylate and ethylene glycol dimethacrylate), styrene derivatives (for example, styrene, divinylbenzene, vinyltoluene and α-methylstyrene), vinyl ethers (for example, methyl vinyl ether, ethyl vinyl ether and cyclohexyl vinyl ether), vinyl esters (for example, vinyl acetate, vinyl propionate and vinyl cinnamate), acrylamides (for example, N-tert-butyl acrylamide and N-cyclohexyl acrylamide), methacrylamides and acrylonitrile derivatives.

The foregoing polymer may be properly used together with a hardening agent described in JP-A-10-25388 and JP-A-10-147739.

### (Light Scattering Layer)

The light scattering layer is formed for the purpose of imparting light diffusibility due to surface scattering and/or internal scattering and hard coat properties for enhancing scratch resistance of the film. Accordingly, the light scattering layer is formed so as to contain a binder for imparting hard coat properties, a mat particle for imparting light diffusibility and optionally an inorganic filler for realizing a high refractive index, preventing crosslinking shrinkage or realizing a high strength.

From the viewpoints of imparting hard coat properties and suppressing the generation of curls and the deterioration of brittleness, the film thickness of the light scattering layer is preferably from 1 to 10 μm, and more preferably from 1.2 to 6 μm.

The binder of the light scattering layer is preferably a polymer having a saturated hydrocarbon chain or a polyether chain as the principal chain, and more preferably a polymer having a saturated hydrocarbon chain as the principal chain. Also, it is preferable that the binder polymer has a crosslinking structure. As the binder polymer having a saturated hydrocarbon chain as the principal chain, polymers of an ethylenically unsaturated monomer are preferable. As the binder polymer having a saturated hydrocarbon chain as the principal chain and having a crosslinking structure, (co)polymers of a monomer having two or more ethylenically unsaturated groups are preferable. In order to make the binder polymer have a high refractive index, those having an aromatic ring or containing at least one atom selected from a halogen atom other than fluorine, a sulfur atom, a phosphorus atom and a nitrogen atom in the monomer structure can be chosen, too.

Examples of the monomer having two or more ethylenically unsaturated groups include esters of a polyhydric alcohol and (meth)acrylic acid (for example, ethylene glycol di (meth) acrylate, butanediol di (meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra (meth) acrylate, dipentaerythritol penta (meth) acrylate, dipentaerythritol hexa(meth)acrylate, pentaerythritol hexa(meth)acrylate, 1,2,3-cyclohexane tetramethacrylate, polyurethane polyacrylates and polyester polyacrylates) and ethylene oxide modified products thereof; vinylbenzene and derivatives thereof (for example, 1,4-divinylbenzene, 2-acryloylethyl 4-vinylbenzoate and 1,4-divinylcyclohexanone); vinylsulfones (for example, divinylsulfone); acrylamides (for example, methylenebisacrylamide); and methacrylamides. Two or more kinds of the foregoing monomers may be used jointly.

Specific examples of the high refractive index monomer include bis(4-methacryloylthiophenyl) sulfide, vinylnaphthalene, vinylphenyl sulfide and 4-methacryloxyphenyl-4′-methoxyphenyl thioether.

The polymerization of such an ethylenically unsaturated group-containing monomer can be carried out upon irradiation with ionizing radiations or heating in the presence of a photo radical initiator or a heat radical initiator.

Accordingly, the antireflection film can be formed by preparing a coating solution containing an ethylenically unsaturated group-containing monomer, a photo radical initiator or a heat radical initiator, a mat particle and an inorganic filler, coating this coating solution on a transparent support and then curing it by a polymerization reaction with ionizing radiations or heat. As such a photo radical initiator, known photo radical initiators can be used.

The polymer having a polyether as the principal chain is preferably a ring-opening polymer of a polyfunctional epoxy compound. The ring-opening polymerization of a polyfunctional epoxy compound can be carried out upon irradiation with ionizing radiations or heating in the presence of a photo acid generator or a heat acid generator.

Accordingly, the antireflection film can be formed by preparing a coating solution containing a polyfunctional epoxy compound, a photo acid generator or a heat acid generator, a mat particle and an inorganic filler, coating this coating solution on a transparent support and then curing it by a polymerization reaction with ionizing radiations or heat.

A crosslinking structure may be introduced into the binder polymer by introducing a crosslinking functional group into the polymer by using a crosslinking functional group-containing monomer in place of, or in addition to, the monomer having two or more ethylenically unsaturated groups and allowing this crosslinking functional group to react.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. As the monomer for the purpose of introducing a crosslinking structure, vinylsulfonic acid, acid anhydrides, cyano acrylate derivatives, melamine, etherified methylol, esters, urethanes and metal alkoxides (for example, tetramethoxysilane) can be utilized. A functional group which exhibits crosslinking properties as a result of decomposition reaction, for example, a block isocyanate group, may also be used. That is, in the invention, the crosslinking functional group may also be a functional group which does not promptly exhibit reactivity but exhibits reactivity as a result of decomposition.

The binder polymer having such a crosslinking functional group is able to form a crosslinking structure upon heating after coating.

For the purpose of imparting antiglare properties, the light scattering layer contains a mat particle which is larger than a filler particle and which has an average particle size of from 1 to 10 μm, and preferably form 1.5 to 7.0 μm, for example, particles of an inorganic compound and resin particles.

Specific examples of the foregoing mat particle which is preferable include particles of an inorganic compound (for example, silica particles and TiO₂ particles) and resin particles (for example, acrylic particles, crosslinked acrylic particles, polystyrene particles, crosslinked styrene particles, melamine resin particles and benzoguanamine resin particles). Of these, crosslinked styrene particles, crosslinked acrylic particles, crosslinked acrylic-styrene particles and silica particles are especially preferable. As to the shape of the mat particle, any of a spherical shape and an amorphous shape can be used.

Also, two or more kinds of mat particles having a different particle size may be used jointly. It is possible to impart antiglare properties by a mat particle having a larger particle size and to impart a separate optical characteristic by a mat particle having a smaller particle size.

Furthermore, as to the particle size distribution of the foregoing mat particle, a monodispersed particle is the most preferable, and it is favorable that the particle size of the respective particles is identical as far as possible. For example, when a particle having a particle size of 20% or more larger than the average particle size is defined as a coarse particle, a proportion of this coarse particle is preferably not more than 1%, more preferably not more than 0.1%, and further preferably not more than 0.01% relative to the whole of particles. A mat particle having such particle size distribution can be obtained by classification after a usual synthesis reaction. By increasing the number of classification or strengthening its degree, it is possible to obtain a matting agent having more preferred particle size distribution.

The foregoing mat particle is contained in the light scattering layer such that the amount of the mat particle in the formed light scattering layer is preferably from 10 to 1,000 mg/m², and more preferably from 100 to 700 mg/m².

The particle size distribution of the mat particle is measured by the Coulter counter method, and the measured distribution is reduced into particle number distribution.

In order to enhance the refractive index of the layer, it is preferable that the light scattering layer contains, in addition to the foregoing mat particle, an inorganic filler which is composed of an oxide of at least one metal selected among titanium, zirconium, aluminum, indium, zinc, tin and antimony and which has an average particle size of not more than 0.2 μm, preferably not more than 0.1 μm, and more preferably not more than 0.06 μm.

Inversely, in order to make a difference in the refractive index from the mat particle large, it is also preferable that an oxide of silicon is used in the light scattering layer using a high refractive index mat particle for the purpose of keeping the refractive index of the layer low. A preferred particle size is the same as in the foregoing inorganic filler.

Specific examples of the inorganic filler to be used in the light scattering layer include TiO₂, ZrO₂, Al₂O₃, In₂O₃, ZnO, SnO₂, Sb₂O₃, ITO and SiO₂. Of these, TiO₂and ZrO₂are especially preferable in view of realizing a high refractive index. It is also preferable that the surface of the inorganic filler is subjected to a silane coupling treatment or a titanium coupling treatment. A surface treating agent having a functional group capable of reacting with a binder species on the filler surface is preferably used.

The addition amount of such an inorganic filler is preferably from 10 to 90%, more preferably from 20 to 80%, and especially preferably from 30 to 75% of the total mass of the light scattering layer.

Since such a filler has a particle size thoroughly smaller than the wavelength of light, scattering is not generated, and a dispersion having the filler dispersed in a binder polymer behaviors as an optically uniform substance.

A refractive index of a bulk of the mixture of the binder and the inorganic filler of the light scattering layer is preferably from 1.48 to 2.00, and more preferably from 1.50 to 1.80. In order to make the refractive index fall within the foregoing range, it would be better that the kind and amount of each of the binder and the inorganic filler are properly chosen. How to choose can be experimentally known with ease in advance.

In particular, in order to ensure uniformity in surface properties against coating unevenness, drying unevenness, point defect, etc., it is preferable that any one or both of a fluorine based surfactant and a silicone based surfactant are contained in a coating composition for forming an antiglare layer. In particular, a fluorine based surfactant is preferably used because it reveals an effect for improving a fault of surface properties of the antireflection film of the invention, such as coating unevenness, drying unevenness and point defect, in a smaller addition amount. This is made for the purpose of increasing the productivity by bringing high-speed coating adaptability while increasing the uniformity in surface properties.

Next, the antireflection layer in which a middle refractive index layer, a high refractive index layer and a low refractive index layer are stacked in this order on a transparent protective film is hereunder described.

An antireflection film composed of a layer configuration in which at least a middle refractive index layer, a high refractive index layer and a low refractive index layer (outermost layer) are stacked in this order on a substrate is designed so as to have a refractive index which is satisfied with the following relationship.

(Refractive index of high refractive index layer)>(Refractive index of middle refractive index layer)>(Refractive index of transparent support)>(Refractive index of low refractive index layer)

Also, a hard coat layer may be provided between the transparent support and the middle refractive index layer. Furthermore, the configuration may be composed of a middle refractive index hard coat layer, a high refractive index layer and a low refractive index layer (see, for example, JP-A-8-122504, JP-A-8-110401, JP-A-10-300902, JP-A-2002-243906 and JP-A-2000-111706). Also, other function may be imparted to each of the layers. For example, a configuration in which an antifouling low refractive index layer and an antistatic high refractive index layer are stacked (those described in, for example, JP-A-10-206603 and JP-A-2002-243906) is exemplified. The haze of the antireflection film is preferably not higher than 5%, and more preferably not more than 3%. Also, the strength of the film is preferably H or more, more preferably 2 H or more, and most preferably 3 H or more in a pencil hardness test in conformity with JIS K5400.

### (High Refractive Index Layer and Middle Refractive Index Layer)

The high refractive index layer of the antireflection film is composed of a curable film containing at least a high refractive index inorganic compound superfine particle having an average particle size of not more than 100 nm and a matrix binder.

Examples of the high refractive index inorganic compound superfine particle include inorganic compounds having a refractive index of 1.65 or more. Of these, those having a refractive index of 1.9 or more are preferable. Examples thereof include oxides of Ti, Zn, Sb, Sn, Zr, Ce, Ta, La, In, etc. and composite oxides containing such a metal atom.

Examples of a method for obtaining such a superfine particle include a treatment of the particle surface with a surface treating agent (for example, a treatment with a silane coupling agent as described in JP-A-11-295503, JP-A-11-153703 and JP-A-20009908; and a treatment with an anionic compound or an organometal coupling agent as described in JP-A-2001-310432); employment of a core/shell structure in which a high refractive index particle is a core (see, for example, JP-A-2001-166104 and JP-A-2001-310432); and joint use with a specified dispersant (see, for example, JP-A-11-153703, U.S. Pat. No. 6,210,858 and JP-A-2002-277609).

Examples of a material which forms the matrix include conventionally known thermoplastic resins and curable resin films.

Furthermore, at least one composition selected from compositions containing a polyfunctional compound having at least two radical polymerizable and/or cationic polymerizable groups and compositions containing a hydrolyzable group-containing organometal compound and a partial condensate thereof is preferable. Examples thereof include compositions described in JP-A-2000-47004, JP-A-2001-315242, JP-A-2001-31871 and JP-A-2001-296401.

Also, a curable film obtained from a colloidal metal oxide obtainable from a hydrolysis condensate of a metal alkoxide and a metal alkoxide composition is preferable. Such is described in, for example, JP-A-2001-293818.

The refractive index of the high refractive index layer is generally from 1.70 to 2.20. The thickness of the high refractive index layer is preferably from 5 nm to 10 μm, and more preferably from 10 nm to 1 μm.

The middle refractive index layer is adjusted so as too have a refractive index which is a value laying between the refractive index of the low refractive index layer and the refractive index of the high refractive index layer. The refractive index of the middle refractive index layer is preferably from 1.50 to 1.70. Also, the thickness of the middle refractive index layer is preferably from 5 nm to 10 μm, and more preferably from 10 nm to 1 μm.

(Low refractive Index Layer)

The low refractive index layer is formed upon being successively staked on the high refractive index layer. The refractive index of the low refractive index layer is from 1.20 to 1.55, and preferably from 1.30 to 1.50.

It is preferable that the low refractive index layer is constructed as an outermost layer having scratch resistance and antifouling properties. As a measure for largely enhancing the scratch resistance, it is effective to impart slipperiness to the surface. A conventionally known measure of a thin film layer by introducing silicone, introducing fluorine or the like can be applied.

The refractive index of the fluorine-containing compound is preferably from 1.35 to 1.50, and more preferably from 1.36 to 1.47. Also, the fluorine-containing compound is preferably a compound having a crosslinking or polymerizable functional group containing a fluorine atom in an amount in the range of from 35 to 80% by mass.

Examples thereof include compounds described in paragraphs [0018] to [0026] of JP-A-9-222503, paragraphs [0019] to [0030] of JP-A-11-38202, paragraphs [0027] to [0028] of JP-A-2001-40284 and JP-A-2000-284102.

The silicone compound is a compound having a polysiloxane structure and is preferably a compound having a curable functional group or a polymerizable functional group in a polymer chain thereof and having a bridged structure in the film. Examples thereof include reactive silicones (for example, SILAPLANE (manufactured by Chisso Corporation)) and polysiloxanes having a silanol group in both ends thereof (see, for example, JP-A-11-258403).

The crosslinking or polymerization reaction of a fluorine-containing and/or siloxane polymer having a crosslinking or polymerizable group can be carried out by coating a coating composition for forming an outermost layer, which contains a polymerization initiator, a sensitizer and the like and at the same time of or after coating, irradiating light or heating.

Also, a sol-gel cured film obtained by curing an organometal compound such as silane coupling agents and a silane coupling agent containing a specified fluorine-containing hydrocarbon group in the co-presence of a catalyst is preferable.

Examples of such a sol-gel cured film include polyfluoroalkyl group-containing silane compounds or partial hydrolysis condensates thereof (for example, compounds described in JP-A-58-142958, JP-A-58-147483, JP-A-58-147484, JP-A-9-157582 and JP-A-11-106704); and silyl compounds having a poly(perfluoroalkyl ether) group which is a fluorine-containing long chain group (for example, compounds described in JP-A-2000-117902, JP-A-2001-48590 and JP-A-2002-53804).

The low refractive index layer can contain a filler (for example, low refractive index inorganic compounds having an average particle size of primary particle of from 1 to 150 nm, for example, silicon dioxide (silica) and fluorine-containing particles (for example, magnesium fluoride, calcium fluoride and barium fluoride); and organic fine particles described in paragraphs [0020] to [0038] of JP-A-11-3820), a silane coupling agent, a lubricant, a surfactant, etc. as additives other than the foregoing additives.

In the case where the low refractive index layer is disposed beneath the outermost layer, the low refractive index layer may be formed by a vapor phase method (for example, a vacuum vapor deposition method, a sputtering method, an ion plating method and a plasma CVD method). A coating method is preferable because the low refractive index layer can be produced at low costs.

The film thickness of the low refractive index layer is preferably from 30 to 200 nm, more preferably from 50 to 150 nm, and most preferably from 60 to 120 nm.

### (Other Layers of Antireflection Layer)

Furthermore, a hard coat layer, a forward scattering layer, a primer layer, an antistatic layer, an under coat layer, a protective layer, etc. may be provided.

### (Hard Coat Layer)

The hard coat layer is provided on the surface of the transparent support for the purpose of imparting a physical strength to the transparent protective film having an antireflection layer provided thereon. In particular, the hard coat layer is preferably provided between the transparent support and the foregoing high refractive index layer. The hard coat layer is preferably formed by a crosslinking reaction or polymerization reaction of a photo-setting and/or thermosetting compound. The curable functional group is preferably a photopolymerizable functional group; and the hydrolyzable functional group-containing organometal compound is preferably an organic alkoxysilyl compound.

Specific examples of such a compound include the same compounds as exemplified in the high refractive index layer. Specific examples of the composition constituting the hard coat layer include those described in JP-A-2002-144913, JP-A-2000-9908 and WO 00/46617.

The high refractive index layer may also act as the hard coat layer. In that case, it is preferable to form the high refractive index layer by finely dispersing a fine particle and incorporating it into a hard coat layer in the same method as in the high refractive index layer.

The hard coat layer can also act as an antiglare layer (as describe later) by incorporating a particle having an average particle size of from 0.2 to 10 μm thereinto to impart an antiglare function.

The film thickness of the hard coat layer can be properly designed depending on applications. The film thickness of the hard coat layer is preferably from 0.2 to 10 μm, and more preferably from 0.5 to 7 μm.

The strength of the hard coat layer is preferably H or more, more preferably 2 H or more, and most preferably 3 H or more in a pencil hardness test in conformity with JIS K5400. It is preferable that an abrasion amount of a specimen before and after the test is small as far as possible in a taber test according to JIS K5400.

### (Antistatic Layer)

In the case where an antistatic layer is provided, it is preferable to impart electrical conductivity of not more than 10⁻⁸ (Ωcm⁻³) in terms of volume resistivity. The use of a hygroscopic substance, a water-soluble inorganic salt, a certain kind of a surfactant, a cation polymer, an anion polymer, colloidal silica, etc. makes it possible to impart a volume resistivity of 10⁻⁸ (Ωcm⁻³). However, these materials have large temperature and relative humidity dependency and encounter a problem that it is impossible to secure sufficient electrical conductivity at a low humidity. For that reason, a metal oxide is preferable as a raw material of the electrically conductive layer. Some metal oxides are colored. The use of such a metal oxide as the raw material of an electrically conductive layer is not preferable because the whole of the film is colored. Examples of a metal capable of forming a colorless metal oxide include Zn, Ti, Sn, Al, In, Si, Mg, Ba, Mo, W and V. The use of a metal oxide composed mainly of such a metal is preferable. Specific examples thereof include ZnO, TiO₂, SnO₂, Al₂O₃, In₂O₃, SiO₂, MgO, BaO, MoO₃, WO₃ and V₂O₅, and composite oxides thereof. Of these, ZnO, TiO₂ and SnO₂ are especially preferable. As to examples of incorporation of different kinds of atoms, the addition of Al, In, etc. is effective for ZnO; the addition of Sb, Nb, a halogen element, etc. is effective for SnO₂; and the addition of Nb, Ta, etc. is effective for TiO₂. Moreover, as described in JP-B-59-6235, a raw material having the foregoing metal oxide attached to other crystalline metal particle or a fibrous material (for example, titanium oxide) may be used. The volume resistivity value and the surface resistivity value are a different physical property value from each other and therefore, cannot be simply compared with each other. However, in order to secure electrical conductivity of not more than 10⁻⁸ (Ωcm⁻³) in terms of volume resistivity, it would be better that the electrically conductive layer has electrical conductivity of not more than about 10⁻¹⁰ (Ω/□), and preferably not more than 10⁻⁸ (Ω/□) in terms of a surface resistivity value. It is necessary that the surface resistivity value of the electrically conductive layer is measured as a value when the antistatic layer is made to function as the most superficial layer. The measurement of the surface resistivity value can be effected at a stage in the course of the formation of a stacked film as described in this specification.

### (Polarizing Plate)

The polarizing plate is composed of a polarizer and two sheets of transparent protective films disposed on the both sides thereof. As one of the protective films, the cellulose acylate film of the invention can be used. As the other protective film, a usual cellulose acetate film may be used. Examples of the polarizer include an iodine based polarizer, a dye based polarizer using a dichroic dye and a polyene based polarizer. The iodine based polarizer and the dye based polarizer are in general produced by using a polyvinyl alcohol based film. In the case where the cellulose acylate film of the invention is used as a polarizing plate protective film, the polarizing plate is not particularly limited with respect to the preparation method and can be prepared by a general method. There is a method in which the resulting cellulose acylate film having been subjected to an alkali treatment is stuck on both surfaces of a polarizer prepared by dipping and stretching a polyvinyl alcohol film in an iodine solution by using a completely saponified polyvinyl alcohol aqueous solution. Easy-adhesion processing described in JP-A-6-94915 and JP-A-6-118232 may be applied in place of the alkali treatment. Examples of the adhesive which is used for sticking the protective film treatment surface and the polarizer include polyvinyl alcohol based adhesives such as polyvinyl alcohol and polyvinyl butyral; and vinyl based latexes such as butyl acrylate. The polarizing plate is configured of a polarizer and protective films for protecting the both surfaces of the polarizer and further configured such that a protective film is stuck on one of the surfaces of the polarizing plate, with a separate film being stuck on the opposite surface thereto. The protective film and the separate film are used for the purpose of protecting the polarizing plate at the shipment of the polarizing plate, the product inspection and so on. In that case, the protective film is stuck for the purpose of protecting the surface of the polarizing plate and is used on an opposite surface side to the surface onto which the polarizing plate is stuck to a liquid crystal plate. Also, the separate film is used for the purpose of covering the adhesive layer to be stuck to a liquid crystal plate and is used on a side of the surface onto which the polarizing plate is stuck to a liquid crystal plate.

In sticking the cellulose acylate film of the invention to the polarizer, it is preferable that sticking is achieved such that a transmission axis of the polarizer and a slow axis of the cellulose acylate film of the invention are coincident with each other. As a result of evaluation of a polarizing plate prepared under a polarizing plate cross nicol, in the case where the orthogonal accuracy of the slow axis of the cellulose acylate film of the invention to the absorption axis (axis orthogonal to the transmission axis) of the polarizer exceeds 1 degree, a polarizing plate constructed under cross nicol suffers from lowering in polarization degree performance and, in its turn, light leaks. In that case, by combining such a polarizing plate with a liquid crystal cell, it is impossible to attain a sufficient black level or contrast. Accordingly, it is preferable that the deviation in angle between the direction of the main refractive index nx of the cellulose acylate film of the invention and the direction of the transmission axis of the polarizing plate is not more than 1 degree, and more preferably not more than 0.5 degrees.

Single-plate transmittance TT, parallel transmittance PT and crossed transmittance CT of the polarizing plate were measured by using UV3100PC (manufactured by Shimadzu Corporation). The measurement was carried out at a wavelength in the range of from 380 nm to 780 nm, and an average value obtained by measurement of 10 times was employed for all of the single-plate transmittance, parallel transmittance and crossed transmittance. A durability test of the polarizing plate was carried out in two kinds of forms including (1) only a polarizing plate and (2) a polarizing plate stuck on glass via an adhesive in the following manner. For the measurement of only a polarizing plate, two polarizers were combined and crossed so as to interpose an optical compensation film therebetween, and two sets of the same material were prepared and provided for the measurement. For the measurement of a polarizing plate stuck on glass, two samples (about 5 cm×5 cm) obtained by sticking a polarizing plate on glass such that an optical compensation film is faced at the glass side are prepared. For the measurement of the single-plate transmittance, the film side of the sample is set towards a light source, and the measurement is carried out. The two samples are respectively measured, and an average value thereof is employed as the single-plate transmittance. With respect to the polarization performance, the single-plate transmittance TT, parallel transmittance PT and crossed transmittance CT are preferably in the ranges of (40.0≦TT≦45.0), (30.0≦PT≦40.0) and (CT≦2.0), and more preferably in the ranges of (41.0≦TT≦44.5), (34≦PT≦39.0) and (CT≦1.3) (all units being %). Also, in the durability test of the polarizing plate, it is preferable that a change amount thereof is small.

Also, in the polarizing plate of the invention, when allowed to stand at 60° C. and 95% RH for 500 hours, a change amount of the crossed single-plate transmittance ΔCT (%) and a change amount of the polarization degree ΔP are satisfied with at least one of the following expressions (j) and (k).

−6.0≦ΔCT≦6.0 (j)

−10.0≦ΔP≦0.0 (k)

Here, the change amount is a value obtained by subtracting a measured value before the test from a measured value after the test.

By meeting this requirement, the stability of the polarizing plate during the use or during the storage is ensured.

The cellulose acylate film of the invention, the optical compensation sheet composed of this film and the polarizing plate using this film can be used in liquid crystal cells and liquid crystal display devices of various display modes. As the display mode of the liquid crystal cell, various display modes such as a TN (twisted nematic) mode, an IPS (in-plane switching) mode, an FLC (ferroelectric liquid crystal) mode, an AFLC (anti-ferroelectric liquid crystal) mode, an OCB (optically compensatory bend) mode, an STN (super twisted nematic) mode, a VA (vertically aligned) mode and an HAN (hybrid aligned nematic) mode are proposed.

A liquid crystal cell of an OCB mode is a liquid crystal display device using a liquid crystal cell of a bend alignment mode in which a rod-like liquid crystalline molecule is aligned in a substantially reverse direction (in a symmetric manner) in the upper and lower parts of a liquid crystal cell and is disclosed in U.S. Pat. Nos. 4,583,825 and 5,410,422. Since the rod-like liquid crystal molecule is symmetrically aligned in the upper and lower parts of a liquid crystal cell, the liquid crystal cell of a bend alignment mode has a self optical compensating ability. A liquid crystal display device of a bend alignment mode involves an advantage that the response speed is fast.

In a liquid crystal cell of a VA mode, a rod-like liquid crystalline molecule is substantially vertically aligned at the time of applying no voltage.

The liquid crystal cell of a VA mode includes, in addition to (1) a liquid crystal cell of a VA mode in a narrow sense in which a rod-like liquid crystalline molecule is substantially vertically aligned at the time of applying no voltage, whereas it is substantially horizontally aligned at the time of applying a voltage (as described in JP-A-2-176625), (2) a liquid crystal cell of a multi-domained VA mode (MVA mode) for enlarging a viewing angle (as described in SID 97, Digest of Tech. Papers, 28 (1997), page 845); (3) a liquid crystal cell of a mode (n-ASM mode) in which a rod-like liquid crystalline molecule is substantially vertically aligned at the time of applying no voltage and is subjected to twisted multi-domain alignment at the time of applying a voltage (as described in Sharp Technical Report, No. 80, page 11); and (4) a liquid crystal cell of a SURVIVAL mode (as announced in Monthly Display, May, page 14 (1999)).

A liquid crystal display device of a VA mode is composed of a liquid crystal cell and two sheets of polarizing plates disposed on the both sides thereof. The liquid crystal cell supports a liquid crystal between two sheets of electrode substrates. In one embodiment of the transmission type liquid crystal display device of the invention, one sheet of the optical compensation sheet of the invention is disposed between the liquid crystal cell and one of the polarizing plates, or two sheets of the optical compensation sheet of the invention are disposed between the liquid crystal cell and each of the both polarizing plates.

In another embodiment of the transmission type liquid crystal display device of the invention, an optical compensation sheet composed of the cellulose acylate film of the invention is used as a transparent protective film of a polarizing plate to be disposed between a liquid crystal cell and a polarizer. The foregoing optical compensation sheet may be used only in the transparent protective film of one of the polarizing plates (between the liquid crystal cell and the polarizer), or the foregoing optical compensation sheet may be used for two sheets of the transparent protective film of the both polarizing plates (between the liquid crystal cell and the polarizer). In the case where the foregoing optical compensation sheet is used only in one of the polarizing plates, it is especially preferable that the optical compensation sheet of the invention is used as a protective film on the liquid crystal cell side of the polarizing plate on a backlight side of the liquid crystal cell. In sticking to the liquid crystal cell, it is preferable that the cellulose acylate film of the invention is faced at the VA cell side. The protective film may be a usual cellulose acylate film, and it is preferable that such a cellulose acylate film is thinner than the cellulose acylate film of the invention. For example, its thickness is preferably from 40 to 80 μm, and examples of the cellulose acylate film include commercially available products such as KC4UX2M (40 μm in thickness, manufactured by Konica Opto Corp.), KC5UX (60 μm in thickness, manufactured by Konica Opto Corp.) and TD80 (80 μm in thickness, manufactured by Fujifilm Corporation). However, it should not be construed that the invention is limited thereto.

### EXAMPLES

The invention is specifically described below with reference to the following Examples, but it should not be construed that the invention is limited thereto.

### Example 1

### (Preparation of Film 1)

### <Preparation of Cellulose Acylate Solution A>

A cellulose acylate and the following composition were charged in a mixing tank and stirred to dissolve the respective components, thereby preparing a cellulose acylate solution A.

Composition of cellulose acylate solution A

| | | |
|---|---|---|
| Cellulose acetate propionate having a | 100.0 | parts by mass |
| degree of acetylation of 1.7 and a degree | | |
| of propionylation of 0.8: | | |
| Triphenyl phosphate (plasticizer): | 6.0 | parts by mass |
| Biphenyl phosphate (plasticizer): | 3.0 | parts by mass |
| Methylene chloride (first solvent): | 302.0 | parts by mass |
| Methanol (second solvent): | 45.0 | parts by mass |

### <Preparation of Matting Agent Solution A>

The following composition was charged in a dispersing machine and stirred to dissolve the respective components, thereby preparing a matting agent solution A.

Composition of matting agent solution A

| | | |
|---|---|---|
| Silica particle having an average | 2.0 | parts by mass |
| particle size of 20 nm (AEROSIL R972, | | |
| manufactured by Nippon Aerosil Co., | | |
| Ltd.): | | |
| Methylene chloride (first solvent): | 75.0 | parts by mass |
| Methanol (second solvent): | 12.7 | parts by mass |
| Cellulose acylate solution A: | 0.3 | parts by mass |

After filtering 1.3 parts by mass of the foregoing matting agent solution A, 92.7 parts by mass of the cellulose acylate solution A was added thereto and mixed by using an in-line mixer; the mixture was cast by using a band casting machine; and immediately thereafter, the cast mixture was dried at a temperature of dry air of 30° C. and a rate of dry air of 1.4 m/s to an extent that the content of the residual solvent reached 40%, followed by stripping off a film. As the dry air, fresh air having an organic solvent concentration of not more than 1% was used. The film with the content of residual solvent of 15% was laterally stretched in a stretch ratio of 1.30 times at a stretching rate of 150%/min at a circumferential temperature of 130° C. by using a tenter and then kept at 130° C. for 30 seconds. Thereafter, a clip was removed, and the film was dried at 120° C. for 40 minutes to prepare a film 1. The prepared film 1 had the content of the residual solvent of 0.1% and a thickness of 80 μm.

### (Preparation of Films 2 to 9)

Films 2 to 9 were prepared in the same manner as in the film 1, except for changing the degree of substitution of cellulose acylate, the charge amount of plasticizer, the temperature of dry air, the rate of dry air and the stretch ratio to those in the contents of the following Table 1.

In the preparation method of the films 1 to 9, since the drying is gradually performed as compared with usual drying, a problem that the casting rate is reduced is generated. Then, it was designed to enhance the productivity at the following two points.

### (Solids Concentration of Dope)

The solids concentration of the dope was set up at 24%, thereby designing to shorten a time required for drying. When dissolution was insufficient, cooling and heating operations were repeated. Whether or not the dissolution was sufficient was judged by visually observing the appearance of the solution.

### (Casting Width)

In order to compensate the reduction of the casting rate, the casting width was set up at 2,500 mm, thereby designing to enlarge an area of the film to be fabricated per unit time.

The above-prepared films 1 to 9 were evaluated with respect to the density of entanglement points, elastic modulus, dimensional stability, Re and Rth at 25° C. and 60 RH % in the following manners.

### (Density of Entanglement Points)

A film sample (5 mm×30 mm) is subjected to humidity conditioning at 25° C. and 60% RH for 2 hours or more and then measured by a dynamic viscoelasticity analyzer (DVA-225, manufactured by IT Keisoku Seigyo Co., Ltd.) at a rate of temperature rise of 2° C./min from 30° C. at a grip distance of 20 mm and a frequency of 1 Hz. When a storage elastic modulus E′ is plotted on the ordinate on a logarithmic scale; a temperature (K) is plotted on the abscissa on a linear scale; and between a glass transition region and a flow region, a start temperature in the rubbery state plateau where E′ exhibits a fixed value is defined as T_{Rs}, and a finish temperature is defined as T_{Rf}, T_{R}=(T_{Rs}+T_{Rf})/2 is defined as a temperature in the rubber state plateau. A density of entanglement points (νe) of the polymer was determined by using a storage elastic modulus E_{R}′ at T_{R} according to the following expression (wherein R represents a gas constant).

νe=E_{R}′/3RT_{R}

### (Elastic Modulus)

An elastic modulus was determined by measuring a stress at an elongation of 0.5% at a tensile rate of 10%/min in an atmosphere of 23° C. and 70% RH using a universal tension tester, STM T50BP (manufactured by Toyo Baldwin Co., Ltd.).

As a specific measurement method, the elastic modulus can be determined by measuring a stress at an elongation of 0.5% at a tensile rate of 10%/min in an atmosphere of 23° C. and 70% RH using a universal tension tester, STM T50BP (manufactured by Toyo Baldwin Co., Ltd.). Furthermore, by drawing the film under the foregoing condition until breakage occurred and measuring the elongation, the breaking elongation was determined.

The evaluation of the breaking elongation was carried out according to the following criteria.

A: The breaking elongation is 40% or more

B: The breaking elongation is 20% or more and less than 40%

C: The breaking elongation is 10% or more and less than 20%

D: The breaking elongation is less than 10%

In the case where the elastic modulus is high, when a stress is applied to the film, a strain is small, and therefore, the film has an excellent mechanical strength; and in the case where the breaking elongation is high, when a stress is applied to the film, the film is hardly broken and has an excellent mechanical strength.

### (Dimensional Stability)

A film sample (30 mm×120 mm) was prepared, humidified at 25° C. and 60% RH for 24 hours and provided with punches of 6 mmφ at intervals of 100 mm in both ends thereof by an automatic pin gauge (manufactured by Shinto Scientific Co., Ltd.); and a punch interval was defined as an original dimension (LO). The sample was treated at 90° C. and 5% RH for 24 hours, followed by measuring a dimension of the punch interval (L1). In the measurement of all of the intervals, the measurement was carried out to a degree of a minimum scale of 1/1000 mm. The rate of dimensional change was determined according to the following expression.

Rate of dimensional change at 90° C. and 5% RH (at a high temperature)={|L0−L1|/L0}×100

The evaluation was carried out according to the following criteria.

A: The rate of dimensional change is less than 0.03%.

B: The rate of dimensional change is 0.03% or more and less than 0.06%.

C: The rate of dimensional change is 0.06% or more and less than 0.10%.

D: The rate of dimensional change is 0.10% or more. (Re and Rth)

Re and Rth of a film at 25° C. and 60% RH at a wavelength of 590 nm were measured by KOBRA 21ADH (manufactured by Oji Scientific Instruments).

### Comparative Example 1

### (Preparation of Film 10)

<Preparation of Cellulose acylate Solution B>

A cellulose acylate and the following composition were charged in a mixing tank and stirred to dissolve the respective components, thereby preparing a cellulose acylate solution B.

Composition of cellulose acylate solution B

| | | |
|---|---|---|
| Cellulose acetate propionate having a | 100.0 | parts by mass |
| degree of acetylation of 1.9 and a degree | | |
| of propionylation of 0.7: | | |
| Triphenyl phosphate (plasticizer): | 6.0 | parts by mass |
| Biphenyl phosphate (plasticizer): | 3.0 | parts by mass |
| Methylene chloride (first solvent): | 402.0 | parts by mass |
| Methanol (second solvent): | 60.0 | parts by mass |

After filtering 1.3 parts by mass of the matting agent solution A as described in Example 1, 92.7 parts by mass of the cellulose acylate solution B was added thereto and mixed by using an in-line mixer; the mixture was cast by using a band casting machine; and immediately thereafter, the cast mixture was dried at a temperature of dry air of 30° C. and a rate of dry air of 1.4 m/s to an extent that the content of the residual solvent reached 40%, followed by stripping off a film. As the dry air, fresh air having an organic solvent concentration of not more than 1% was used. The film with the content of residual solvent of 15% was laterally stretched in a stretch ratio of 1.30 times at a stretching rate of 150%/min at a circumferential temperature of 130° C. by using a tenter and then kept at 130° C. for 30 seconds. Thereafter, a clip was removed, and the film was dried at 120° C. for 40 minutes to prepare a film 10. The prepared film 10 had the content of the residual solvent of 0.1% and a thickness of 80 μm.

### (Preparation of Films 11 to 16)

Films 11 to 16 were prepared in the same manner as in the film 10, except for changing the degree of substitution of cellulose acylate, the charge amount of plasticizer, the temperature of dry air, the rate of dry air and the stretch ratio to those in the contents of the following Table 1.

The above-prepared films 10 to 16 were evaluated in the same manners as in Example 1 with respect to the density of entanglement points at 25° C. and 60% RH, elastic modulus, dimensional stability, Re and Rth.

### Example 2

### (Preparation of Film 17)

### <Preparation of Cellulose Acylate Solution C>

A cellulose acylate and the following composition were charged in a mixing tank and stirred to dissolve the respective components, thereby preparing a cellulose acylate solution C.

Composition of cellulose acylate solution C

| | | |
|---|---|---|
| Cellulose acetate propionate having a | 100.0 | parts by mass |
| degree of acetylation of 1.9 and a degree | | |
| of propionylation of 0.7: | | |
| Triphenyl phosphate (plasticizer): | 6.0 | parts by mass |
| Biphenyl phosphate (plasticizer): | 3.0 | parts by mass |
| Methylene chloride (first solvent): | 302.0 | parts by mass |
| Methanol (second solvent): | 45.0 | parts by mass |

After filtering 1.3 parts by mass of the matting agent solution A as described in Example 1, 92.7 parts by mass of the cellulose acylate solution C was added thereto and mixed by using an in-line mixer, and the mixture was cast by using a band casting machine. The band casting machine was put in a casing, and the casing was sealed. An air inlet and an air exit were placed in the casing and connected to each other. An air blower was placed between the air inlet and the air exit, thereby circulating the atmosphere in the casing. An air volume ratio ((air volume for circulation per minute)/(casing volume)) was adjusted at 2 by this air blower. Also, the organic solvent gas concentration in the casing was adjusted at 20% by a condenser placed in the inside of this circulation system. The temperature of air to be circulated was set up at 38° C. The cast mixture was dried to an extent that the content of the residual solvent reached 40%, followed by stripping off a film. The film with the content of residual solvent of 15% was laterally stretched in a stretch ratio of 1.30 times at a stretching rate of 150%/min at a circumferential temperature of 130° C. by using a tenter and then kept at 130° C. for 30 seconds. Thereafter, a clip was removed, and the film was dried at 120° C. for 40 minutes to prepare a film 17. The prepared film 17 had the content of the residual solvent of 0.1% and a thickness of 80 μm.

### (Preparation of Film 18)

A film 18 was prepared in the same manner as in the film 17, except for setting up the volume ratio ((air volume for circulation per minute)/(casing volume)) and the organic solvent gas concentration at 4 and 10%, respectively.

In the preparation method of the films 17 and 18, since the drying is gradually performed as compared with usual drying, a problem that the casting rate is reduced is generated. Then, it was designed to enhance the productivity at the following two points.

### (Solids Concentration of Dope)

The solids concentration of the dope was set up at 24%, thereby designing to shorten a time required for drying. When dissolution was insufficient, cooling and heating operations were repeated. Whether or not the dissolution was sufficient was judged by visually observing the appearance of the solution.

### (Casting Width)

In order to compensate the reduction of the casting rate, the casting width was set up at 2,500 mm, thereby designing to enlarge an area of the film to be fabricated per unit time.

The above-prepared films 17 and 18 were evaluated in the same manners as in Example 1 with respect to the density of entanglement points at 25° C. and 60% RH, elastic modulus, dimensional stability, Re and Rth.

TABLE 1

| | Cellulose acylate | | | Triphenyl | Biphenyl | | | | |
|---|---|---|---|---|---|---|---|---|---|
| | Degree of | Degree of | Total degree | phosphate | phosphate | Temperature | Rate of dry | | |
| | substitution | substitution | of | (parts by | (parts by | of dry air | air | Stretch ratio | |
| | of Ac | of Pr | substitution | mass) | mass) | (° C.) | (m/s) | (Times) | Remark |
| Film 1 | 1.7 | 0.8 | 2.5 | 6.0 | 3.0 | 30 | 1.4 | 1.3 | Invention |
| Film 2 | 1.9 | 0.7 | 2.6 | 6.0 | 3.0 | 30 | 1.4 | 1.3 | Invention |
| Film 3 | 2.1 | 0.6 | 2.7 | 6.0 | 3.0 | 30 | 1.4 | 1.3 | Invention |
| Film 4 | 1.7 | 0.8 | 2.5 | 6.0 | 3.0 | 38 | 2.7 | 1.3 | Invention |
| Film 5 | 1.9 | 0.7 | 2.6 | 6.0 | 3.0 | 38 | 2.7 | 1.3 | Invention |
| Film 6 | 2.1 | 0.6 | 2.7 | 6.0 | 3.0 | 38 | 2.7 | 1.3 | Invention |
| Film 7 | 1.7 | 0.8 | 2.5 | 3.0 | 1.5 | 30 | 1.4 | 1.3 | Invention |
| Film 8 | 1.9 | 0.7 | 2.6 | 3.0 | 1.5 | 30 | 1.4 | 1.3 | Invention |
| Film 9 | 2.1 | 0.6 | 2.7 | 3.0 | 1.5 | 30 | 1.4 | 1.3 | Invention |
| Film 10 | 1.9 | 0.7 | 2.6 | 6.0 | 3.0 | 50 | 1.4 | 1.3 | Comparison |
| Film 11 | 1.9 | 0.7 | 2.6 | 6.0 | 3.0 | 50 | 5.0 | 1.3 | Comparison |
| Film 12 | 1.9 | 0.7 | 2.6 | 6.0 | 3.0 | 100 | 1.4 | 1.3 | Comparison |
| Film 13 | 1.9 | 0.7 | 2.6 | 6.0 | 3.0 | 100 | 5.0 | 1.3 | Comparison |
| Film 14 | 1.9 | 0.7 | 2.6 | 3.0 | 1.5 | 50 | 1.4 | 1.3 | Comparison |
| Film 15 | 1.9 | 0.7 | 2.6 | 3.0 | 1.5 | 50 | 5.0 | 1.3 | Comparison |
| Film 16 | 2.1 | 0.6 | 2.7 | 3.0 | 1.5 | 20 | 0.5 | 1.3 | Comparison |
| Film 17 | 1.9 | 0.7 | 2.6 | 6.0 | 3.0 | 38 | 2.5 | 1.3 | Invention |
| Film 18 | 1.9 | 0.7 | 2.6 | 6.0 | 3.0 | 38 | 2.6 | 1.3 | Invention |

TABLE 2

| | Density of | | | Dimensional | | | |
|---|---|---|---|---|---|---|---|
| | entanglement | Elastic modulus | Breaking | stability | | | |
| | points | (MD/TD) | elongation | (MD/TD) | Re | Rth | |
| | (mole/dm³) | (GPa) | (MD/TD) | (%) | (nm) | (nm) | Remark |
| Film 1 | 0.40 | 4.1/5.1 | A/A | C/B | 50 | 135 | Invention |
| Film 2 | 0.71 | 4.5/5.5 | A/A | A/A | 48 | 130 | Invention |
| Film 3 | 0.89 | 4.6/5.7 | A/B | A/A | 46 | 120 | Invention |
| Film 4 | 0.32 | 4.1/5.0 | A/A | C/C | 50 | 130 | Invention |
| Film 5 | 0.56 | 4.3/5.4 | A/A | B/B | 48 | 120 | Invention |
| Film 6 | 0.81 | 4.5/5.7 | A/A | A/A | 45 | 115 | Invention |
| Film 7 | 0.90 | 4.6/5.7 | A/B | A/A | 52 | 135 | Invention |
| Film 8 | 1.5 | 4.9/5.8 | B/C | A/A | 49 | 125 | Invention |
| Film 9 | 1.9 | 5.1/5.9 | C/C | A/A | 46 | 120 | Invention |
| Film 10 | 0.21 | 2.8/3.8 | A/A | D/C | 48 | 115 | Comparison |
| Film 11 | 0.18 | 2.6/3.5 | A/A | D/C | 47 | 113 | Comparison |
| Film 12 | 0.10 | 2.5/3.2 | A/A | D/D | 47 | 110 | Comparison |
| Film 13 | 0.08 | 2.3/3.0 | A/A | D/D | 48 | 108 | Comparison |
| Film 14 | 0.28 | 3.1/4.2 | A/A | D/C | 49 | 120 | Comparison |
| Film 15 | 0.25 | 2.9/4.0 | A/A | D/C | 49 | 118 | Comparison |
| Film 16 | 2.5 | 5.6/6.3 | C/D | A/A | 49 | 122 | Comparison |
| Film 17 | 0.67 | 4.4/5.6 | A/A | A/A | 47 | 126 | Invention |
| Film 18 | 0.64 | 4.4/5.5 | A/A | A/A | 48 | 123 | Invention |

In Table 2, MD represents a longitudinal direction of the film, and TD represents a direction substantially orthogonal thereto.

As is clear from Table 2, the films 1 to 9, 17 and 18 of the invention have a high density of entanglement points of a polymer chain as compared with the films 10 to 15. Following this, in the films of the invention, since the entanglement of a polymer chain is generated densely, even when a stress is generated, the deformation is hardly caused, and the elastic modulus becomes high. The elastic modulus relies upon not only the density of entanglement points but a degree of crystallization and a degree of orientation. However, since the degree of crystallization and the degree of orientation are a parameter capable of largely changing optical characteristics, it is difficult to control the both at the same time. Then, according to the invention, it has become possible to prepare a film capable of realizing a high elastic modulus while revealing desired optical characteristics and having excellent mechanical strength and dimensional stability by controlling a parameter named as a degree of entanglement points, which relatively hardly affects the optical characteristics.

Though the film 16 of the comparison has a high elastic modulus, it is poor in view of the breaking elongation. Therefore, its mechanical strength was on a problematic level.

### Example 3

### (Saponification Treatment)

The film 1 as prepared in Example 1 was dipped in a 1.5 N sodium hydroxide aqueous solution at 55° C. for 3 minutes. The film 1 was rinsed in a water-washing bath tank at room temperature and then neutralized with 0.1 N sulfuric acid at 30° C. The resulting film 1 was again rinsed in a water-washing bath tank at room temperature and then dried by warm air at 100° C. The surface of the film 1 was thus saponified.

### (Preparation of Polarizing Plate)

A polarizing film was prepared by adsorbing iodine on a stretched polyvinyl alcohol film. Next, the prepared film 1 was stuck on one side of the polarizing film by using a polyvinyl alcohol based adhesive. A slow axis of the film 1 and a transmission axis of the polarizing film were disposed such that the both were parallel to each other.

A commercially available cellulose triacetate film (FUJITAC TD80UF, manufactured by Fujifilm Corporation) was subjected to a saponification treatment in the same manner as in the film 1 and stuck on the opposite side of the foregoing polarizing film by using a polyvinyl alcohol based adhesive. There was thus prepared a polarizing plate 1.

Polarizing plates 2 to 9, 17 and 18 were prepared in the same manner as in the polarizing plate 1, except for using the films 2 to 9, 17 and 18, respectively in place of the film 1.

### Example 4

### (Preparation of Liquid Crystal Display Device)

A polarizing plate on a backlight side of a liquid crystal cell of a commercially available liquid crystal television set of a VA mode (LC-37GE2, manufactured by Sharp Corporation) was stripped off, and the above-prepared polarizing plate 1 was stuck thereto via an adhesive such that it was faced at the liquid crystal cell side. Since the transmission axis of the polarizing plate on the observer side was in the vertical direction, the stack was disposed in a state of cross nicol such that the transmission axis of the polarizing plate on the backlight side was in the horizontal direction. There was thus prepared a liquid crystal display device 1.

### Example 5

Liquid crystal display devices 2 to 9, 17 and 18 were prepared in the same manner as in Example 4, except for using the polarizing plates 2 to 9, 17 and 18, respectively in place of the polarizing plate 1.

### (Evaluation of Liquid Crystal Display Device)

All of the liquid crystal display devices 2 to 9, 17 and 18 of the invention were excellent in the color taste, viewing angle and contrast.

This application is based on Japanese Patent application JP 2007-068573, filed Mar. 16, 2007, the entire content of which is hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. A cellulose acetate propionate film having a density νe of entanglement points of a polymer chain of cellulose acetate propionate represented by the following expression (A) of from 0.3 to 2.0 moles/dm³:
νe=E_{R}′/3RT_{R} (A)
wherein R represents a gas constant; E_{R}′ represents a storage elastic modulus in a rubbery state plateau upon measurement of a dynamic viscoelasticity; and T_{R} represents a temperature in the rubbery state plateau.

2. The cellulose acetate propionate film according to claim 1, wherein an elastic modulus in one of a longitudinal direction of the film and a direction substantially orthogonal thereto is from 4.0 to 6.0 GPa, and an elastic modulus in the other direction is from 5.0 to 6.0 GPa.

3. The cellulose acetate propionate film according to claim 1, which is free from a compound having a crosslinking structure.

4. The cellulose acetate propionate film according to claim 1, wherein Re is satisfied with a range of the following expression (B), and Rth is satisfied with a range of the following expression (C):
30 nm≦Re≦100 nm (B)
70 nm≦Rth≦300 nm (C)
wherein Re represents an in-plane retardation value of the film against light having a wavelength of 590 nm at 25° C. and 60% RH; and Rth represents a retardation value of the film in a thickness direction against light having a wavelength of 590 nm at 25° C. and 60% RH.

5. A process for producing a cellulose acetate propionate film, which comprises:
casting a dope containing cellulose acetate propionate and a solvent on a band; and
drying the cast dope by blowing dry air at a temperature of from 25° C. to 40° C. at a rate of from 1 to 3 m/s until a content of the residual solvent has reached not more than 70%.

6. The process for producing a cellulose acetate propionate film according to claim 5, wherein a solids concentration of the dope at the time of casting is from 23 to 27%.

7. The process for producing a cellulose acetate propionate film according to claim 5, wherein a casting width of the film is from 2,000 to 3,000 mm.

8. The process for producing a cellulose acetate propionate film according to claim 5, which comprises: casting the dope on the band in an atmosphere having an organic solvent gas concentration in a range of from 5 to 30% to form a cast film and drying the cast film.

9. The cellulose acetate propionate film according to claim 1, which is produced by a process comprising:
casting a dope containing cellulose acetate propionate and a solvent on a band; and
drying the cast dope by blowing dry air at a temperature of from 25° C. to 40° C. at a rate of from 1 to 3 m/s until a content of the residual solvent has reached not more than 70%.

10. An optical compensation sheet comprising the cellulose acetate propionate film according to claim 1.

11. A polarizing plate comprising two transparent protective films and a polarizing film provided between the transparent protective films, wherein at least one of the transparent protective films is the cellulose acetate propionate film according to claims 1.

12. A liquid crystal display device comprising two polarizing plates and a liquid crystal cell provided between the polarizing plates, wherein at least one of the polarizing plates is the polarizing plate according to claim 11.
